(19) United States
(12) Patent Application Publication
(10) Pub. No.: US 2015/0355578 A1
(43) Pub. Date: Dec. 10, 2015

(54) TONER CONTAINER AND IMAGE FORMING APPARATUS WITH A MECHANISM TO SECURE THE TONER CONTAINER

(71) Applicants: Kenji KIKUCHI, Kanagawa (JP); Eisuke HORI, Tokyo (JP); Yuji SUZUKI, Tokyo (JP); Hideki KIMURA, Kanagawa (JP); Nobuo TAKAMI, Kanagawa (JP); Noriyuki KIMURA, Kanagawa (JP)

(72) Inventors: Kenji KIKUCHI, Kanagawa (JP); Eisuke HORI, Tokyo (JP); Yuji SUZUKI, Tokyo (JP); Hideki KIMURA, Kanagawa (JP); Nobuo TAKAMI, Kanagawa (JP); Noriyuki KIMURA, Kanagawa (JP)

(21) Appl. No.: 14/829,320

(22) Filed: Aug. 18, 2015

Related U.S. Application Data
(62) Division of application No. 14/307,185, filed on Jun. 17, 2014, now Pat. No. 9,146,499.
Application No. 14/307,185 is a continuation of application No. 13/411,134, filed on Mar. 2, 2012, now Pat. No. 8,792,809.
Application No. 13/411,134 is a continuation of application No. PCT/JP2010/059968, filed on Jun. 11, 2010.

(30) Foreign Application Priority Data
Sep. 4, 2009 (JP) 2009-204368
Sep. 4, 2009 (JP) 2009-204403
Sep. 4, 2009 (JP) 2009-204459
May 27, 2010 (JP) 2010-121808
May 27, 2010 (JP) 2010-121919
May 27, 2010 (JP) 2010-121974

(51) Int. Cl. G03G 15/08

(52) U.S. Cl. CPC G03G 15/0889

(57) ABSTRACT

A toner container and system for mounting and/or securing the toner container includes a toner container having a toner dispensing hole, a shutter, a protrusion. The shutter is movable relative to the toner dispensing hole, and is to selectively close the toner dispensing hole. The protrusion is connected to the shutter and movement of the protrusion causes the shutter to move relative to the toner dispensing hole to cover the toner dispensing hole. There is a receiver including a movable catch, the movable catch being in a first position when the toner container is initially inserted into the receiver, and the movable catch moving to a second position upon insertion of the toner container into the receiver. The movable catch interacts with the protrusion of the toner container when the toner container is being removed from the receiver such that the movable catch in the second position restricts movement of the protrusion of the toner container which closes the shutter as the toner container is withdrawn from the receiver.

### CROSS REFERENCES TO RELATED APPLICATIONS

The present application is a divisional of U.S. application Ser. No. 14/307,185 filed on Jun. 17, 2014, which is a continuation of U.S. application Ser. No. 13/411,134 (now U.S. Pat. No. 8,792,809) filed on Mar. 2, 2012 which is based upon and claims the benefit of priority of PCT Application No. PCT/JP2010/059968 filed on Jun. 11, 2010, the entire contents of each of which are incorporated herein by reference. The present application is based upon and claims the benefit of priority of Japanese Patent Application Laid-open No. 2010-121919, filed on May 27, 2010, Japanese Patent Application Laid-open No. 2010-121974, filed on May 27, 2010, Japanese Patent Application Laid-open No. 2010-121808, filed on May 27, 2010, Japanese Patent Application Laid-open No. 2009-204459, filed on Sep. 4, 2009, Japanese Patent Application Laid-open No. 2009-204403, filed Sep. 4, 2009, and Japanese Patent Application Laid-open No. 2009-204368, filed on Sep. 4, 2009, the entire contents of each of which are incorporated herein by reference. The present application further incorporates herein by reference the entire contents of the U.S. Patent Application Publication No. 2006/0034642, filed Feb. 16, 2006, and U.S. Patent Application Publication No. 2004/0223790, filed on Nov. 11, 2004.

### FIELD

The present invention relates to a toner container for use in a copier, a printer, or an image forming apparatus such as a multifunction peripheral that has the functions of a copier, a printer, and/or a facsimile machine, and relates to an image forming apparatus including the toner container.

### BACKGROUND

In conventional image forming apparatuses such as copiers, a cylindrical toner container (a toner bottle) that is detachably attached to a main body of an image forming apparatus has been widely used (see, for example, Patent Document 1 and Patent Document 2). Patent Documents 1 and 2 disclose a toner container (a toner bottle) that is set in a body of an image forming apparatus in a replaceable manner and that mainly includes a container body (a bottle body) and a cap unit (a held unit).

Patent Document 1: Japanese Patent Application Laid-open No. H4-1681

Patent Document 2: Japanese Patent Application Laid-open No. 2002-268344

### SUMMARY

A toner container detachably attached to a body of an image forming apparatus that includes a first holding member, a second holding member, and a shutter closing mechanism such that a longitudinal direction of the toner container is kept horizontal includes: a toner outlet for discharging toner; a shutter unit that moves along an outer periphery of the toner container to open and close the toner outlet; a shutter rail for guiding the shutter unit to move in the longitudinal direction for opening and closing the toner outlet; and a projection that protrudes from the toner container in the longitudinal direction so as to protrude from an end portion of the shutter unit in a closing direction with the end portion located at a position where the toner outlet is closed. The shutter rail has two surface members that are disposed, respectively, on one side and another side of the toner container, and are extending in the longitudinal direction, the projection has surfaces that are respectively in the same planes as planes of the surface members of the shutter rail, the toner outlet is opened and closed by moving the shutter unit on the shutter rail, the surface members are to be sandwiched by the first holding member, the shutter unit is switched between a held state in which the shutter unit is held by the second holding member and a released state in which holding of the shutter unit by the second holding member is released in accordance with rotation of the second holding member, and the shutter unit is prevented by the shutter closing mechanism, which makes the second holding member incapable of rotating, from being open while the surface members are sandwiched by the first holding member.

### BRIEF DESCRIPTION OF DRAWINGS

FIG. 1 is an overall configuration diagram of an image forming apparatus according to a first embodiment of the present invention;

FIG. 2 is a cross-sectional view of an image forming unit;

FIG. 3 is a schematic diagram of how a toner container is set in a toner supply device;

FIG. 4 is a schematic perspective view of how toner containers are set in a toner-container holder.

FIG. 5 is a perspective view of the toner container viewed obliquely from above;

FIG. 6 is a perspective view of the toner container viewed obliquely from below;

FIG. 7 illustrates six sides of the toner container;

FIG. 8 is a front view of the toner container viewed from a cap unit side;

FIG. 9 is an exploded view of the toner container;

FIG. 10 is a perspective view of a container body of the toner container;

FIG. 11 is a perspective view of a cap unit of the toner container;

FIG. 12 is another perspective view of the cap unit of the toner container;

FIG. 13 is a perspective view of the cap unit of the toner container when viewed from a side of the cap unit to which the container body is connected;

FIG. 14 is another perspective view of the cap unit of the toner container when viewed from the side of the cap unit to which the container body is connected;

FIG. 15 is a perspective view of a state in which a shutter unit of the toner container closes a toner outlet;

FIG. 16 is a perspective view of how the shutter unit of the toner container opens the toner outlet;

FIG. 17 is a perspective view of a state in which the shutter unit of the toner container opens the toner outlet;

FIGS. 18A to 18C are schematic diagrams illustrating opening operation performed by the shutter unit in association with attachment operation of the toner container to a toner-container holder;

FIG. 19 is a perspective view of the cap unit from which the shutter unit is removed;

FIG. 20 is a perspective view of a first member of the cap unit;

FIG. 21 is another perspective view of the first member of the cap unit;

FIG. 22 is a perspective view of a second member of the cap unit;

FIG. 23 is a perspective view of the shutter unit;

FIG. 24 is another perspective view of the shutter unit;

FIG. 25 is a cross-sectional view of the vicinity of the cap unit of the toner container;

FIG. 26 is a perspective view of the interior of the cap unit of the toner container;

FIGS. 27A to 27D are front views illustrating states in which different toner containers are inserted into insertion ports as viewed from the cap unit side;

FIG. 28 is a perspective view of a bottle holder of the toner-container holder;

FIG. 29 is a top view of the bottle holder of the toner-container holder;

FIG. 30 is an enlarged perspective view of the vicinity of a leading-end portion of the bottle holder;

FIG. 31 is another enlarged perspective view of the vicinity of the leading-end portion of the bottle holder;

FIG. 32 is still another enlarged perspective view of the vicinity of the leading-end portion of the bottle holder;

FIG. 33 is a perspective view of a cap holder of the toner-container holder;

FIG. 34 is an enlarged perspective view of a part of the cap holder;

FIG. 35 is another enlarged perspective view of a part of the cap holder;

FIG. 36 is a perspective view of the interior of the cap holder;

FIG. 37 is a cross-sectional view of the cap holder;

FIG. 38 is a perspective view of how the toner container is set in the toner-container holder;

FIG. 39 is a bottom view of how the shutter unit of the toner container opens the toner outlet while being engaged with a shutter holding mechanism of the toner-container holder;

FIG. 40 is a bottom view illustrating a state following the state illustrated in FIG. 39;

FIG. 41 is a bottom view illustrating a state following the state illustrated in FIG. 40;

FIGS. 42A to 42D are schematic diagrams illustrating procedures in which each portion of the cap holder is engaged with the cap unit when the attachment operation of the toner container proceeds;

FIG. 43 is a schematic perspective view of the cap unit of the toner container and a seal member of the toner-container holder;

FIGS. 44A to 44B are schematic perspective views illustrating another configuration of the cap unit of the toner container and the seal member of the toner-container holder;

FIG. 45 is an exploded view of a part of a toner container according to a second embodiment of the present invention;

FIG. 46 is a perspective view of a head side of a container body of the toner container illustrated in FIG. 45;

FIG. 47 is a perspective view of a cap unit of the toner container of FIG. 45;

FIG. 48 is another perspective view of the cap unit of the toner container illustrated in FIG. 45;

FIG. 49 is a cross-sectional perspective view of the cap unit of the toner container of FIG. 45;

FIG. 50 is a cross-sectional view of the vicinity of the cap unit of the toner container illustrated in FIG. 45;

FIG. 51 is a perspective view of a state in which the shutter unit of the toner container of FIG. 45 closes the toner outlet;

FIG. 52 is a perspective view of a state in which the shutter unit of the toner container illustrated in FIG. 45 opens the toner outlet;

FIG. 53 is a perspective view of a stirring member of a toner container according to a third embodiment of the present invention;

FIG. 54 is another perspective view of the stirring member illustrated in FIG. 53;

FIG. 55 illustrates three sides view of the stirring member illustrated in FIG. 53;

FIGS. 56A to 56D are schematic front views of how the stirring member illustrated in FIG. 53 rotates;

FIGS. 57A to 57D schematic front views of how the stirring member of the toner container illustrated in FIG. 45 rotates;

FIG. 58 is a schematic cross-sectional view of a cap unit of a toner container according to a fourth embodiment of the present invention;

FIG. 59 is a perspective view of a flexible member disposed near a toner outlet of the toner container illustrated in FIG. 57;

FIGS. 60A to 60G schematic front views of how a stirring member of the toner container illustrated in FIG. 57 rotates; and

FIG. 61 is a configuration diagram of a toner container having another configuration.

### DESCRIPTION OF EMBODIMENTS

Exemplary embodiments of the present invention will be described in detail below with reference to the accompanying drawings. In the drawings, the same or equivalent components are denoted by the same reference letters or numerals, and explanation thereof will be appropriately simplified or omitted.

### First Embodiment

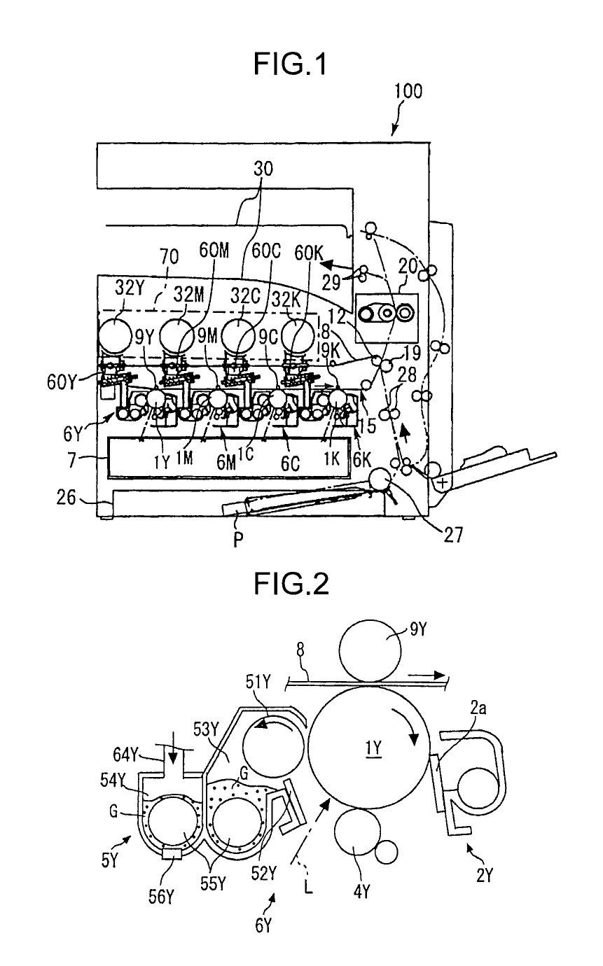

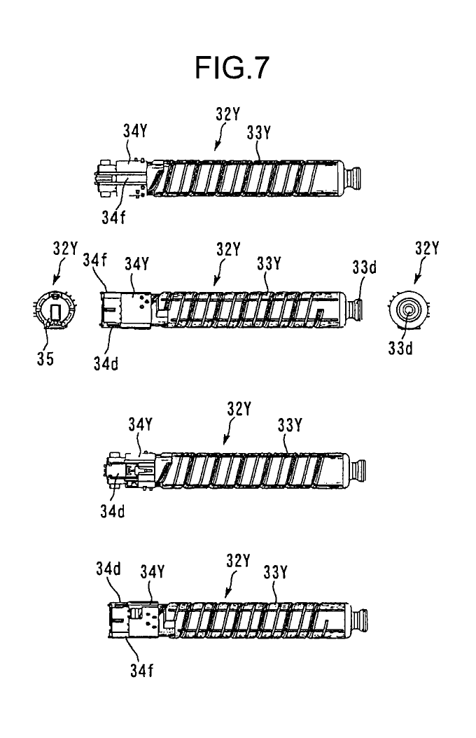

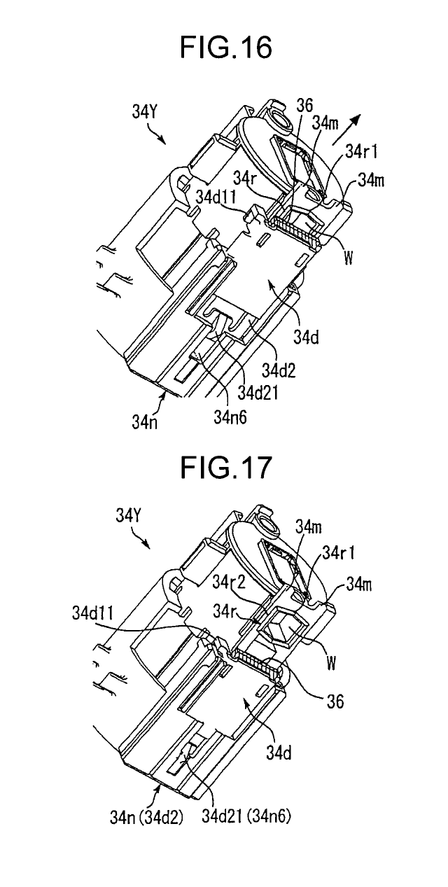

A first embodiment will be described in detail below with reference to FIGS. 1 to 44. The configuration and operation of whole of the image forming apparatus are described first.

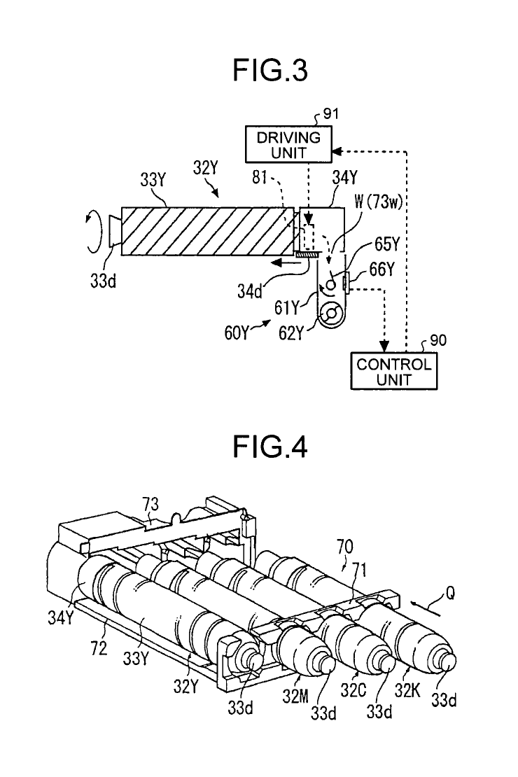

As illustrated in FIG. 1, four toner containers 32Y, 32M, 32C, and 32K corresponding to respective colors (yellow, magenta, cyan, and black) are detachably (in a replaceable manner) arranged in a toner-container holder 70 provided on the upper side of a body of an image forming apparatus 100 (also see FIGS. 3, 4, and 38). An intermediate transfer unit 15 is arranged below the toner-container holder 70. Image forming units 6Y, 6M, 6C, and 6K corresponding to the respective colors (yellow, magenta, cyan, and black) are arranged in a line so as to face an intermediate transfer belt 8 of the intermediate transfer unit 15. Toner supply devices 60Y, 60M, 60C, and 60K are arranged below the toner containers 32Y, 32M, 32C, and 32K, respectively. The toner supply devices 60Y, 60M, 60C, and 60K supply (feed) toner contained in the toner containers 32Y, 32M, 32C, and 32K to developing devices in the image forming units 6Y, 6M, 6C, and 6K, respectively.

Referring to FIG. 2, the image forming unit 6Y for yellow includes a photosensitive drum 1Y, and also includes a charging unit 4Y, a developing device 5Y (a developing unit), a cleaning unit 2Y, and a neutralizing unit (not illustrated), which are arranged around the photosensitive drum 1Y. Image forming processes (charging process, exposing process, developing process, transfer process, and cleaning process) are preformed on the photosensitive drum 1Y, on which a yellow image is formed.

The other three image forming units 6M, 6C, and 6K have almost the same configurations as the image forming unit 6Y for yellow except that colors of toners to be used are different and images corresponding to the respective toner colors are formed. In the followings, explanation of the other three image forming units 6M, 6C, and 6K will be appropriately omitted, and explanation of only the image forming unit 6Y for yellow will be given.

Referring to FIG. 2, the photosensitive drum 1Y is rotated clockwise in a plane of FIG. 2 by a drive motor (not illustrated). The surface of the photosensitive drum 1Y is uniformly charged at the position of the charging unit 4Y (charging process). The surface of the photosensitive drum 1Y then reaches a position of radiating a laser light L emitted from an exposing device 7 (see FIG. 1), where an exposing light is scanned to form an electrostatic latent image for yellow (exposing process).

The surface of the photosensitive drum 1Y then reaches a position of facing the developing device 5Y, where the electrostatic latent image is developed and a yellow toner image is formed (developing process). The surface of the photosensitive drum 1Y then reaches a position of facing the intermediate transfer belt 8 and a primary-transfer bias roller 9Y, where the toner image on the photosensitive drum 1Y is transferred to the intermediate transfer belt 8 (primary transfer process). At this time, a slight amount of non-transferred toner remains on the photosensitive drum 1Y.

The surface of the photosensitive drum 1Y then reaches a position to face the cleaning unit 2Y, where the non-transferred toner remaining on the photosensitive drum 1Y is mechanically collected by a cleaning blade 2a (cleaning process). The surface of the photosensitive drum 1Y finally reaches a position to face the neutralizing unit (not illustrated), where the residual potential on the photosensitive drum 1Y is removed. In this manner, a series of the image forming professes performed on the photosensitive drum 1Y is completed.

The image forming processes are performed on the other image forming units 6M, 6C, and 6K in the same manner as the yellow image forming unit 6Y. Specifically, the exposing device 7 arranged below the image forming units emits a laser light L based on image information toward each photosensitive drum of the image forming units 6M, 6C, and 6K. More specifically, the exposing device 7 emits the laser light L from a light source, and radiates the laser light L onto the photosensitive drum through a plurality of optical elements while scanning the laser light L by a polygon mirror being rotated. Subsequently, color toner images formed on the respective photosensitive drums through the developing process are superimposed and transferred onto the intermediate transfer belt 8. In this manner, a color image is formed on the intermediate transfer belt 8.

Referring to FIG. 1, the intermediate transfer unit 15 includes the intermediate transfer belt 8, four primary-transfer bias rollers 9Y, 9M, 9C, and 9K, a secondary-transfer backup roller 12, a plurality of tension rollers, an intermediate-transfer cleaning unit, and the like. The intermediate transfer belt 8 is stretched and supported by a plurality of rollers, and is endlessly moved in a direction indicated by an arrow in FIG. 1 in association with a rotation of the secondary-transfer backup roller 12.

The four primary-transfer bias rollers 9Y, 9M, 9C, and 9K sandwich the intermediate transfer belt 8 with the photosensitive drums 1Y, 1 M, 1 C, and 1K, respectively, to form primary transfer nips. A transfer bias with an opposite polarity to a polarity of toner is applied to the primary-transfer bias rollers 9Y, 9M, 9C, and 9K. The intermediate transfer belt 8 moves in the direction indicated by the arrow in FIG. 1 and sequentially passes through the primary transfer nips of the primary-transfer bias rollers 9Y, 9M, 9C, and 9K. Accordingly, the toner images for respective colors on the photosensitive drums 1Y, 1 M, 1 C, and 1K are superimposed on the intermediate transfer belt 8 as primary transfers.

The intermediate transfer belt 8 carrying the superimposed and transferred toner images of a plurality of colors reaches a position to face a secondary transfer roller 19. At this position, the secondary-transfer backup roller 12 sandwiches the intermediate transfer belt 8 with the secondary transfer roller 19 to form a secondary transfer nip. The four-color toner image formed on the intermediate transfer belt 8 is transferred to a recording medium P, such as a transfer sheet, that has been conveyed to the position of the secondary transfer nip. At this time, non-transferred toner which has not been transferred to the recording medium P remains on the intermediate transfer belt 8.

The intermediate transfer belt 8 then reaches the position of the intermediate-transfer cleaning unit (not illustrated), where the non-transferred toner on the intermediate transfer belt 8 is collected. In this manner, a series of the transfer process performed on the intermediate transfer belt 8 is completed.

The recording medium P is conveyed to the position of the secondary transfer nip from a feed unit 26, which is disposed on the lower side of the body of the image forming apparatus 100, via a feed roller 27 and a registration roller pair 28. More specifically, a plurality of recording media P, such as transfer sheets, is stacked in the feed unit 26. When the feed roller 27, as drawn in FIG. 1, is rotated counterclockwise, the topmost recording medium P is fed to a nip between rollers of the registration roller pair 28.

The recording medium P conveyed to the registration roller pair 28 temporarily stops at the position of the nip between the rollers, which are stopped of driven rotation, of the registration roller pair 28. The registration roller pair 28 is rotated in association with the color image on the intermediate transfer belt 8, and the recording medium P is conveyed toward the secondary transfer nip. Then, a desired color image is transferred to the recording medium P.

The recording medium P to which the color image is transferred at the position of the secondary transfer nip is conveyed to the position of a fixing unit 20, where the color image transferred to the surface of the recording medium P is fixed to the recording medium P by heat and pressure applied by a fixing belt and a pressing roller. The recording medium P is then discharged to the outside of the apparatus through a nip between rollers of a discharging roller pair 29. The recording medium P discharged to the outside of the apparatus by the discharging roller pair 29 is sequentially stacked on a stack portion 30 as an output image. In this manner, a series of the image forming processes in the image forming apparatus is completed.

The configuration and operation of the developing device in the image forming unit are described in detail below with reference to FIG. 2. The developing device 5Y includes a developing roller 51Y to face the photosensitive drum 1Y, a doctor blade 52Y to face the developing roller 51Y, two conveyor screws 55Y disposed in developer storage units 53Y and 54Y, and a density detection sensor 56Y for detecting toner density in developer. The developing roller 51Y includes a magnet fixed inside thereof and a sleeve that rotates around the magnet. Two-component developer G formed of carrier and toner is stored in the developer storage units 53Y and 54Y. The developer storage unit 54Y communicates with a toner-falling conveying path 64Y via an opening formed on an upper side of the developer storage unit 54Y.

The developing device 5Y configured as above operates as follows. The sleeve of the developing roller 51Y rotates in a direction indicated by an arrow in FIG. 2. The developer G, which is carried on the developing roller 51Y by a magnetic field formed by the magnet, moves along the developing roller 51Y in association with rotation of the sleeve.

The developer G in the developing device 5Y is controlled so that the proportion (toner density) of toner in the developer is in a predetermined range. More specifically, toner contained in the toner container 32Y is supplied to the developer storage unit 54Y via the toner supply device 60Y (see FIG. 3) according to toner consumption in the developing device 5Y. The configuration and operation of the toner supply device will be described in detail below.

The toner supplied to the developer storage unit 54Y circulates in the two developer storage units 53Y and 54Y while being mixed and stirred together with the developer G (movement in a direction perpendicular to the sheet of FIG. 2) by the two conveyor screws 55Y. The toner in the developer G adheres to the carrier by triboelectric charging with the carrier, and is carried on the developing roller 51Y together with the carrier due to the magnetic force formed on the developing roller 51Y.

The developer G carried on the developing roller 51Y is conveyed in the direction indicated by the arrow in FIG. 2 and reaches the position of the doctor blade 52Y. After the amount is adjusted at this position, the developer G on the developing roller 51Y is conveyed to the position (development area) to face the photosensitive drum 1Y. The toner adheres to a latent image formed on the photosensitive drum 1Y by an electric field formed in the development area. The developer G remaining on the developing roller 51Y reaches the upper side of the developer storage unit 53Y in association with the rotation of the sleeve, where the developer G is separated from the developing roller 51Y.

Referring to FIGS. 3 and 4, the toner supply devices 60Y, 60M, 60C, and 60K are described in detail below. Referring to FIG. 3, toner in the toner containers 32Y, 32M, 32C, and 32K arranged in the toner-container holder 70 of the body of the image forming apparatus 100 is appropriately supplied to the respective developing devices by the toner supply devices 60Y, 60M, 60C, and 60K, which are arranged for the respective toner colors, according to toner consumption in the developing devices for the respective colors. The four toner supply devices 60Y, 60M, 60C, and 60K have almost the same configurations and the four toner containers 32Y, 32M, 32C, and 32K have almost the same configurations, except that colors of toners used for the image forming processes are different from each other. Therefore, explanation will be given only of the toner supply device 60Y and the toner container 32Y for yellow, and explanation of the toner supply devices 60M, 60C, and 60K and the toner containers 32M, 32C, and 32K for the other three colors will be omitted appropriately.

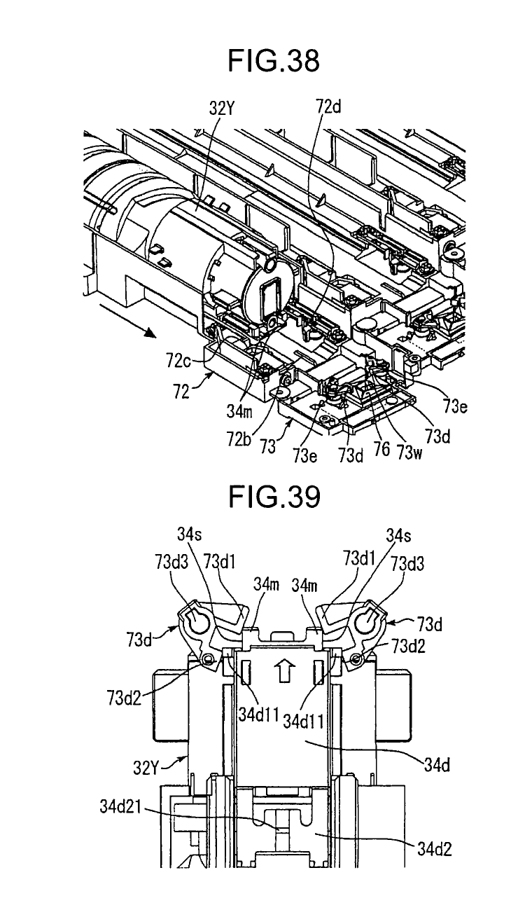

As illustrated in FIG. 4, when the toner containers 32Y, 32M, 32C, and 32K are attached to the toner-container holder 70 of the body of the image forming apparatus 100 (movement in a direction indicated by an arrow Q), a shutter unit 34d of each of the toner containers 32Y, 32M, 32C, and 32K moves in association with the attachment operation. Accordingly, a toner outlet W is opened and a toner supply port 73w of each of the toner supply devices 60Y, 60M, 60C, and 60K (see FIGS. 3 and 38) and the toner outlet W operate together. Consequently, toner contained in the toner container 32Y (same for 32M, 32C, and 32K) is discharged from the toner outlet W and is accumulated in a toner tank 61Y (same for 61M, 61C, and 61K) through the toner supply ports 73w of the toner supply device 60Y, 60M, 60C, and 60K.

Referring to a schematic diagram of FIG. 3, the toner container 32Y is an approximately cylindrical toner bottle, and mainly includes a cap unit 34Y that is held in a non-rotatable manner held by the toner-container holder 70 and a container body (bottle body) 33Y that has an integrally-formed gear 33c. The container body 33Y is held so as to rotate relative to the cap unit 34Y, and is driven by a driving unit 91 (which includes a drive motor, a driving gear 81, and the like) to rotate in the direction indicated by an arrow in FIG. 3. In association with rotation of the container body 33Y, toner contained in the toner container 32Y (the container body 33Y) is conveyed in a longitudinal direction (conveyed from left to right in FIG. 3) by a spiral-shaped projection 33b formed on the inner circumferential surface of the container body 33Y, and the toner is discharged from the toner outlet W of the cap unit 34Y. That is, the driving unit 91 appropriately rotates the container body 33Y of the toner container 32Y, so that toner is appropriately supplied to the toner tank 61Y. The toner containers 32Y, 32M, 32C, and 32K are replaced with new ones at the end of their lifetimes (when almost all of toner contained is consumed and the container becomes empty).

Referring to FIG. 3, each of the toner supply devices 60Y, 60M, 60C, and 60K includes the toner-container holder 70, the toner tank unit 61Y, a toner conveyor screw 62Y, a stirring member 65Y, a toner end sensor 66Y, and the driving unit 91. The toner tank unit 61Y is arranged below the toner outlet W of the toner container 32Y for accumulating toner discharged from the toner outlet W of the toner container 32Y. The bottom portion of the toner tank unit 61Y is connected to an upstream portion of the toner conveyor screw 62Y. The toner end sensor 66Y for detecting that the amount of toner accumulated in the toner tank unit 61Y becomes equal to or smaller than a predetermined amount is set on a wall surface of the toner tank unit 61Y (at a position with a predetermined height from the bottom portion). A piezoelectric sensor or the like may be used as the toner end sensor 66Y. When a control unit 90 detects, by using the toner end sensor 66Y, that the amount of toner accumulated in the toner tank 61Y becomes equal to or smaller than the predetermined amount (toner end detection), the control unit 90 controls the driving unit 91 (the driving gear 81) to rotate the container body 33Y of the toner container 32Y for a predetermined period of time so as to supply toner to the toner tank unit 61Y. When the toner end detection by the toner end sensor 66Y is not cancelled even after the above control is repeated, information for urging replacement of the toner container 32Y is displayed on a display unit (not illustrated) of the body of the image forming apparatus 100 on the presumption that the toner container 32Y is out of toner.

The stirring member 65Y that prevents toner accumulated in the toner tank unit 61Y from being cohered is disposed at the center (near the toner end sensor 66Y) of the toner tank unit 61Y. The stirring member 65Y has a flexible member arranged at a shaft portion thereof. The stirring member 65Y rotates clockwise in FIG. 3 so as to stir toner in the toner tank unit 61Y. A tip of the flexible member of the stirring member 65Y comes into slide contact with a detection surface of the toner end sensor 66Y at every rotational period so as to prevent reduction in detection accuracy due to toner stuck to the detection surface of the toner end sensor 66Y.

The toner conveyor screw 62Y conveys, though the details are not illustrated in the figure, toner accumulated in the toner tank unit 61Y in an obliquely upper direction. Specifically, the toner conveyor screw 62Y conveys toner from the bottom portion (a bottommost point) of the toner tank unit 61Y toward an upper side of the developing device 5Y straight. Toner conveyed by the toner conveyor screw 62Y falls through the toner-falling conveying path 64Y (see FIG. 2) by falling due to own weight and is supplied to the developing device 5Y (developer storage unit 54Y).

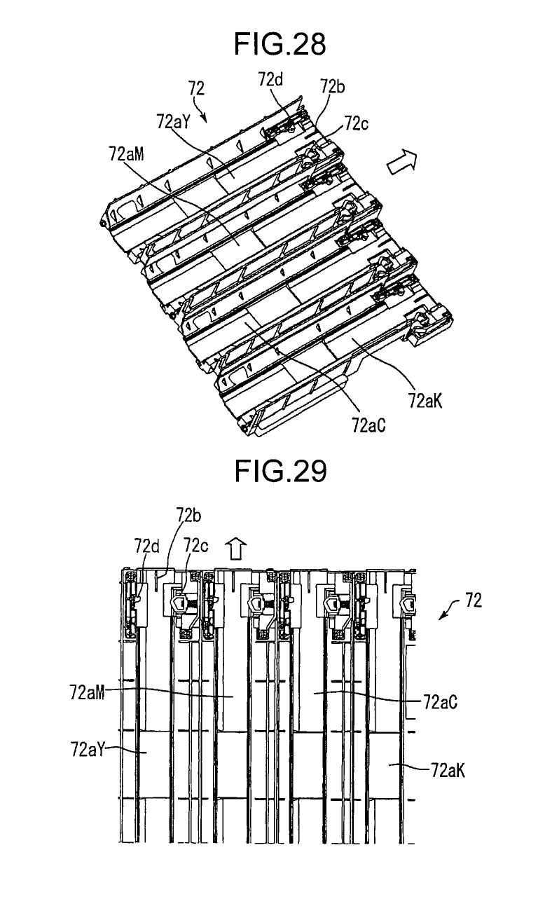

Referring to FIG. 4, the toner-container holder 70 mainly includes a cap holder 73 for holding the cap unit 34Y of the toner container 32Y, a bottle holder 72 (container-body holder) for holding the container body 33Y of the toner container 32Y, and an insertion port 71 serving as an insertion port in the attachment operation of the toner container 32Y. The configuration of the toner-container holder 70 (the bottle holder 72 and the cap holder 73) will be described in detail later with reference to FIGS. 28 to 42.

Referring to FIG. 1, when a body cover (not illustrated) arranged at a front side (a front side in a direction perpendicular to the sheet of FIG. 1) of the body of the image forming apparatus 100 is opened, the toner-container holder 70 (the insertion port 71) is exposed. While each of the toner containers 32Y, 32M, 32C, and 32K is kept such that its longitudinal direction is horizontal, attachment/detachment operation of each of the toner containers 32Y, 32M, 32C, and 32K is performed from the front side of the body of the image forming apparatus 100 (the attachment/detachment operation using the longitudinal direction of the toner container as an attachment/detachment direction).

The bottle holder 72 is formed such that the length thereof in the longitudinal direction is nearly equal to the length of the container body 33Y in the longitudinal direction. The cap holder 73 is provided on one end of the bottle holder 72 in the longitudinal direction (attachment direction) while the insertion port 71 is provided on the other end of the bottle holder 72 in the longitudinal direction (attachment direction). Thus, along with the attachment operation of the toner container 32Y, the cap unit 34Y slides on the bottle holder 72 for a while after passing through the insertion port 71, and thereafter is set to the cap holder 73.

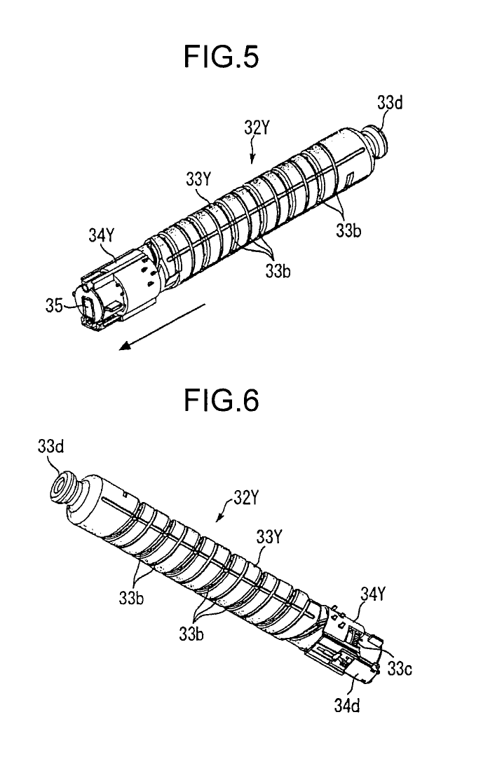

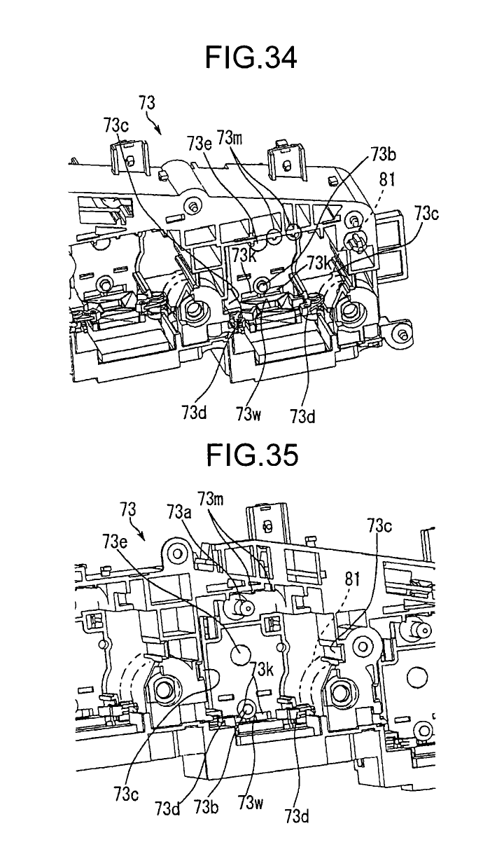

In the first embodiment, an antenna 73e (radio-frequency identification (RFID) antenna) is mounted on the cap holder 73 of the toner-container holder 70 in which the toner containers 32Y, 32M, 32C, and 32K are detachably mounted in a line (see FIGS. 34 and 35). More specifically, the antenna 73e is used for communicating with an RFID chip 35 (see FIGS. 5 and 9) that is an electronic-information storage member mounted on an end face of the cap unit 34Y of the toner container 32Y.

The RFID chip 35 (electronic-information storage member) of each of the toner containers 32Y, 32M, 32C, and 32K exchanges necessary information with the antenna 73e (RFID antenna) mounted on the body of the image forming apparatus 100. Examples of the information exchanged between the RFID chip 35 and the antenna 73e include information on a manufacturing number of the toner container, the number of times the toner container has been recycled, information on the amount of toner that the toner container can contain, a lot number of the toner container, and toner color, and information on usage of the body of the image forming apparatus 100. The above electronic information is stored in the RFID chip 35 (electronic-information storage member) in advance before the RFID chip 35 is mounted on the body of the image forming apparatus 100 (or information received from the body of the image forming apparatus 100 after the chip is mounted is stored).

Referring to FIGS. 5 to 26, the toner containers 32Y, 32M, 32C, and 32K will be described in detail. As illustrated in FIGS. 5 to 7, the toner container 32Y mainly includes the container body 33Y (bottle body) and the cap unit 34Y (bottle cap) arranged on the head of the container body. Referring to FIG. 9, the toner container 32Y further includes, in addition to the container body 33Y and the cap unit 34Y, a stirring member 33f, a cap seal 37, the shutter unit 34d, a shutter seal 36 as a seal member, and the RFID chip 35 as the electronic-information storage member.

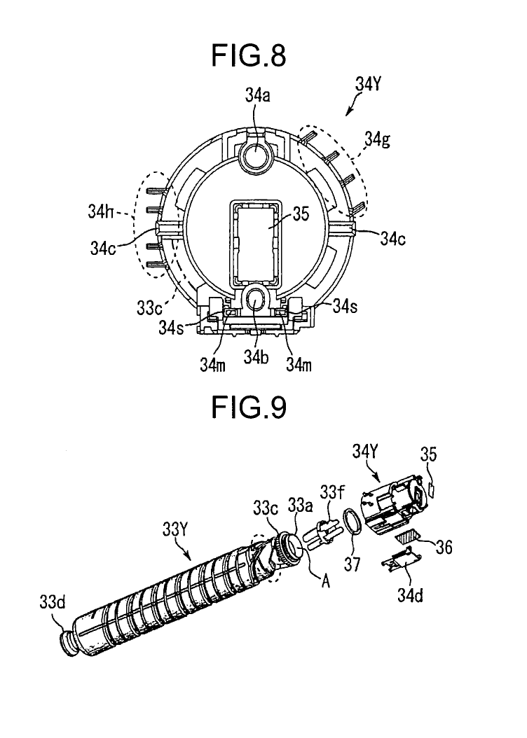

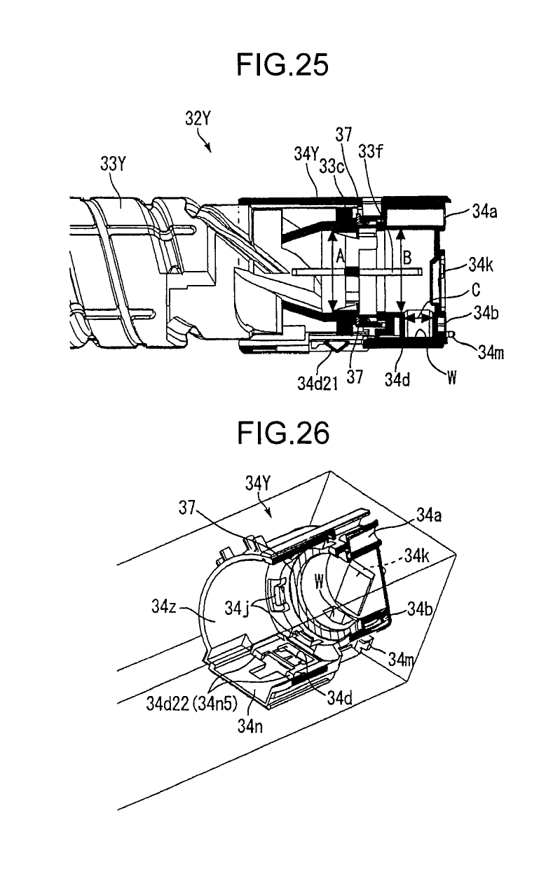

The gear 33c, which rotates with the container body 33Y together, and an opening A are arranged on one end of the container body 33Y in the longitudinal direction (a direction perpendicular to the sheet of FIG. 8) (see FIG. 9). The opening A is provided on the head of the container body 33Y (front end position in the attachment operation), and is used for discharging toner contained in the container body 33Y into a space (a cavity B, see FIG. 25) in the cap unit 34Y. Toner is appropriately conveyed from the container body 33Y to the cavity B in the cap unit 34Y (conveyance is induced by the rotation of the container body 33Y) to the extent that toner in the cap unit 34Y does not fall below a predetermined draft line.

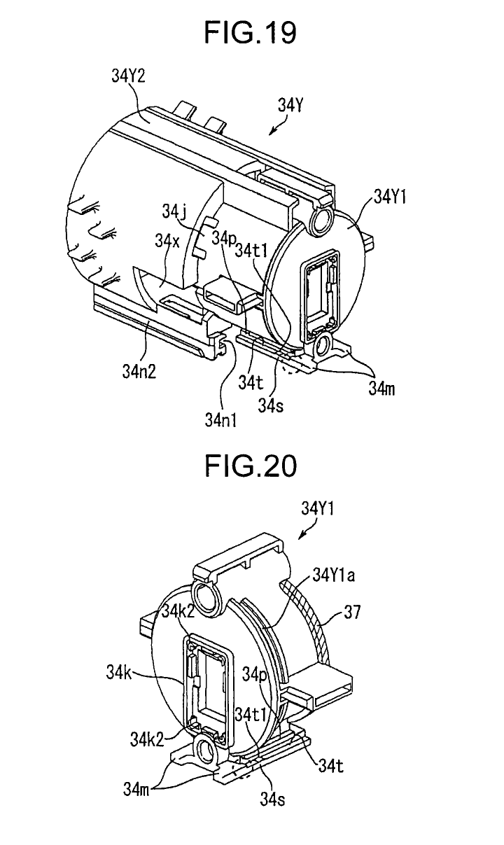

The gear 33c is engaged with the driving gear 81 arranged in the toner-container holder 70 of the body of the image forming apparatus 100 to thereby rotate the container body 33Y about an axis of the rotation. More specifically, the gear 33c is formed to circle around the circumference of the opening A, and includes a plurality of teeth that are radially arranged with respect to the axis of the rotation of the container body 33Y. A part of the gear 33c is exposed through a notch portion 34x (see FIG. 19) formed on the cap unit 34Y, and is engaged with the driving gear 81 of the body of the image forming apparatus 100 at an engagement position on the lower left side of FIG. 8. Driving force is transmitted from the driving gear 81 to the gear 33c, so that the container body 33Y rotates clockwise in FIG. 8. In the first embodiment, the driving gear 81 and the gear 33c are realized as spur gears.

Referring to FIGS. 5 and 6, a gripper 33d is arranged on the other end of the container body 33Y in the longitudinal direction (a trailing end in the attachment direction) so that a user can grip the gripper 33d in attaching/detaching the toner container 32Y. The user attaches the toner container 32Y to the body of the image forming apparatus 100 by gripping the gripper 33d (movement of the toner container 32Y in the direction indicated by an arrow in FIG. 5).

The spiral-shaped projection 33b is arranged on the inner circumferential surface of the container body 33Y (a spiral-shaped groove when viewed from the outer circumferential surface side). The spiral-shaped projection 33b is used for discharging toner from the opening A in association with the rotation of the container body 33Y in a predetermined direction. The container body 33Y configured as above can be manufactured by blow molding with the gear 33c of the container body 33Y, which is arranged on the circumferential surface, and the gripper 33d together.

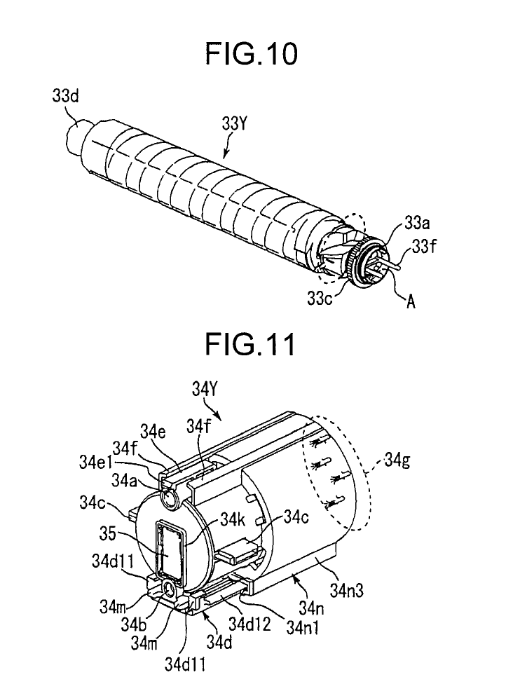

Referring to FIGS. 9 and 10, the toner container 32Y according to the first embodiment includes the stirring member 33f that rotates together with the container body 33Y and that is fitted to a bottle opening 33a (the opening A). The stirring member 33f is formed of a pair of rod-shaped members that extend from the cavity B in the cap unit 34Y to inside of the container body 33Y (also see FIG. 25). Rotation of the stirring member 33f together with the opening A of the container body 33Y improves the toner discharging performance from the opening A.

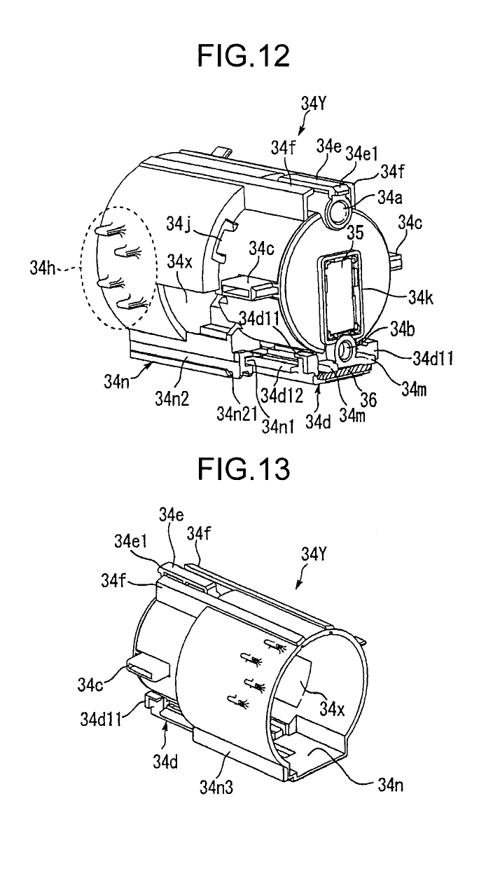

Referring to FIGS. 9 and 10, engaging members (convex portions), which are engaged with claw members 34j (see FIGS. 12 and 26) of the cap unit 34Y in order to connect the container body 33Y and the cap unit 34Y to each other, are formed to circle around the outer circumference of the bottle opening 33a of the container body 33Y. As described above, the container body 33Y is engaged with the cap unit 34Y in such a manner that the container body 33Y is rotatable with respect to the cap unit 34Y. Therefore, the gear 33c rotates relative to the cap unit 34Y when the container body 33Y rotates.

The inner diameter of a head portion of the container body 33Y (near the position where the gear 33c is formed) is smaller than the inner diameter of a toner-containing portion of the toner container (the position where the spiral-shaped projection 33b is formed) (also see FIG. 25). The scooping portion (the portion surrounded by a dashed circle in FIGS. 9 and 10), of which the inner circumferential surface protrudes inward, is provided on the head of the container body 33Y. Toner conveyed toward the opening A by the spiral-shaped projection 33b in association with the rotation of the container body 33Y is scooped, by the scooping portion (the portion surrounded by a dashed circle in FIGS. 9 and 10), into a small-diameter portion of the head. The toner scooped into the small-diameter portion of the head is stirred by the stirring member 33f, and is discharged to the cavity B of the cap unit 34Y through the opening A.

Referring to FIGS. 11 to 14, the shutter unit 34d, the shutter seal 36 (seal member), the cap seal 37, and the RFID chip 35 (electronic-information storage member) are arranged on the cap unit 34Y of the toner container 32Y. The cap unit 34Y includes an insertion portion 34z with an inner diameter greater than the inner diameter of the cavity B (see FIG. 26), and the opening A of the container body 33Y is inserted into the insertion portion 34z. Referring to FIGS. 17 and 25, the toner outlet W is formed at the bottom portion of the cap unit 34Y to allow toner that has been discharged from the opening A of the container body 33Y to be discharged to the outside of the toner container in a vertically downward direction (to fall by own weight). The shutter unit 34d for opening and closing the toner outlet W is held in a movable way by sliding at the bottom portion of the cap unit 34Y. More specifically, the shutter unit 34d moves by a relative motion in the longitudinal direction from the cap unit 34Y side to the container body 33Y side (movement to the left in FIG. 25) to open the toner outlet W, and the shutter unit 34d moves by a relative motion in the longitudinal direction from the container body 33Y side to the cap unit 34Y side (movement to the right in FIG. 25) to close the toner outlet W. The open/close operation of the shutter unit 34d (the open/close operation of the toner outlet W) is performed in association with the attachment/detachment operation of the toner container 32Y to the toner-container holder 70 (the body of the image forming apparatus 100) in the longitudinal direction.

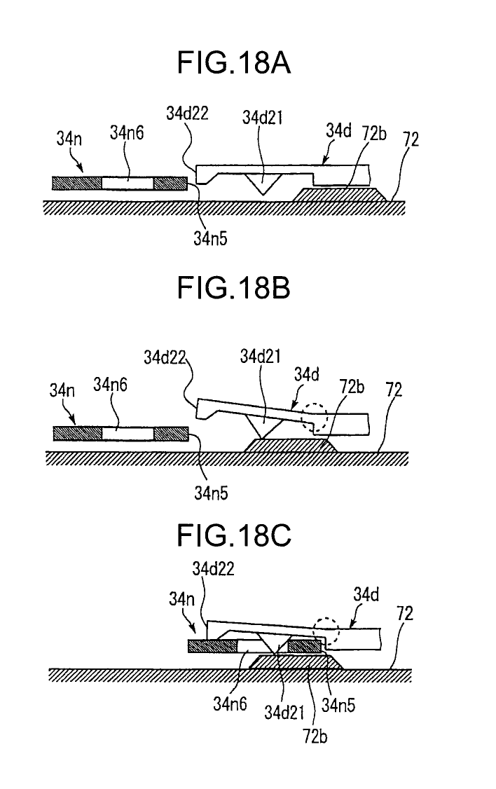

FIGS. 15 to 17 illustrate operation of the shutter unit 34d from start to completion of opening the toner outlet W. FIG. 18 is a schematic diagram illustrating the opening operation of the shutter unit 34d (a deformable shutter member 34d2).

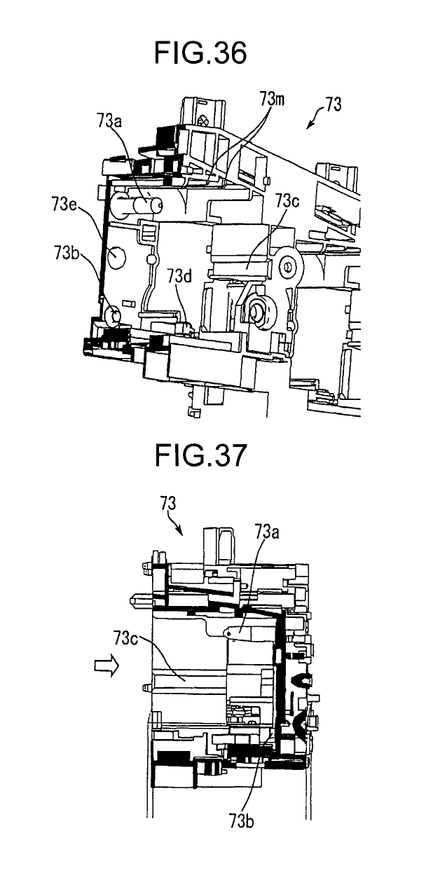

Referring to FIGS. 11 and 12, a first hole 34a is formed at the upper portion (ceiling portion) of the cap unit 34Y such that the first hole 34a extends in the longitudinal direction from the end face, which is perpendicular to the longitudinal direction, of the cap unit 34Y. The first hole 34a functions as a main guide for positioning the cap unit 34Y in the body of the image forming apparatus 100. More specifically, the first hole 34a of the cap unit 34Y is engaged with a main guide pin 73a (see FIGS. 35 and 36) of the cap holder 73 in association with the attachment operation of the toner container 32Y to the toner-container holder 70 in the longitudinal direction.

A second hole unit 34b is formed at the lower portion (bottom portion) of the cap unit 34Y such that the second hole unit 34b extends in the longitudinal direction from the end face, which is perpendicular to the longitudinal direction, of the cap unit 34Y so as not to reach the position of the toner outlet W. The second hole unit 34b functions as a sub-guide for positioning the cap unit 34Y in the body of the image forming apparatus 100. More specifically, the second hole unit 34b of the cap unit 34Y is engaged with a sub-guide pin 73b (see FIGS. 35 and 36) of the cap holder 73 in association with the attachment operation of the toner container 32Y to the toner-container holder 70 in the longitudinal direction. As illustrated in FIG. 8, a cross section of the second hole unit 34b is an ellipse of which a major axis is parallel to the vertical direction.

With the use of the two holes 34a and 34b configured as above, the cap unit 34Y is positioned in the toner-container holder 70. Referring to FIG. 8, a virtual vertical line passing through the center of the first hole 34a and a virtual vertical line passing through the center of the second hole 34b are the same and identical straight line to pass through the center of the circle of the cap unit 34Y when viewed in the plane perpendicular to the longitudinal direction.

Referring to FIG. 25, the depth of the first hole 34a (or the length of the main guide pin 73a in the longitudinal direction) is greater than the depth of the second hole 34b (or the length of the sub-guide pin 73b in the longitudinal direction). Therefore, during the attachment operation of the toner container 32Y to the toner-container holder 70 (the cap holder 73) in the longitudinal direction, engagement of the main guide pin 73a with the first hole 34a as the main positioning guide is started first, and thereafter, engagement of the sub-guide pin 73b with the second hole 34b as the sub-positioning guide is started. This allows the toner container 32Y to be smoothly attached to the toner-container holder 70 (the cap holder 73). The first hole 34a that is long in the longitudinal direction is arranged on the ceiling portion of the cap unit 34Y (a portion that is not buried in toner), so that toner conveying capability (flowability) in the cap unit 34Y is not influenced by the first hole. Although the second hole 34b that is short in the longitudinal direction is arranged at the bottom portion of the cap unit 34Y, the second hole 34b can be arranged by using a small space between the end face of the cap unit 34Y and the position of the toner outlet W and can fully function as the sub-positioning guide.

Referring to FIGS. 11 to 14, a first engaging portion 34e and a second engaging portions 34f, which function as regulators for regulating the posture of the cap unit 34Y in the horizontal direction perpendicular to the longitudinal direction in the cap holder 73 of the body of the image forming apparatus 100, are formed on the ceiling portion of the cap unit 34Y. The first engaging portion 34e and the second engaging portions 34f protrude upward in the vertical direction from the outer circumferential surface of the cap unit 34Y and are line-symmetric with respect to a virtual vertical line passing through the center of the first hole 34a when viewed in the cross section perpendicular to the longitudinal direction (a cross section parallel to the front view of FIG. 8), and the first engaging portion 34e and the second engaging portions 34f extend in the longitudinal direction (a direction perpendicular to the sheet of FIG. 8). The first engaging portion 34e and the second engaging portions 34f are engaged with an engaged portion 73m (convex portion) of the cap holder 73 illustrated in FIG. 34. Therefore, the cap unit 34Y is attached to and detached from the cap holder 73 while the posture of the cap unit 34Y in the horizontal direction is regulated, and also, the posture of the cap unit 34Y in the horizontal direction is regulated during when the cap unit 34Y is attached to the cap holder 73.

More specifically, the first engaging portion 34e (regulator) is formed just above the first hole unit 34a, and has an approximately rectangular cross section when viewed in the cross section perpendicular to the longitudinal direction. The first engaging portion 34e includes a protrusion 34e1 that protrudes in the longitudinal direction (attachment direction) relative to the end face of the first hole unit 34a. A tip of the protrusion 34e1 has a tapered shape as illustrated in FIG. 11. In contrast, the second engaging portions 34f (regulators) are formed on both sides of the first engaging portion 34e and sandwich the first engaging portion 34e. Each of the second engaging portions 34f has an approximately L-shaped cross section when viewed in the cross sectional plane that is perpendicular to the longitudinal direction (i.e., in a cross section parallel to the front view of FIG. 8). The first engaging portion 34e is engaged with the two engaged portions 73m formed on the cap holder 73 so as to be set between the engaged portions while the two second engaging portions 34f are engaged with the engaged portions 73m so as to sandwich the two engaged portions 73m entirely from outside. When the cap unit 34Y is attached to the cap holder 73, the tapered protrusion 34e1 of the first engaging portion 34e is engaged with the engaged portion 73m before the second engaging portions 34f are engaged with the engaged portion 73m, so that the cap unit 34Y can be smoothly attached to the cap holder 73.

Referring to FIGS. 11 to 14 again, lateral projections 34c, which function as a second regulator for regulating the posture of the cap unit 34Y in the rotational direction in the body of the image forming apparatus 100 (the cap holder 73), are formed on both lateral sides of the cap unit 34Y. The lateral projections 34c (the second regulator) on both sides protrude in the horizontal direction from the outer circumferential surface of the cap unit 34Y such that both of the lateral projections 34c are arranged to be in a virtually drawn horizontal line that passes a midpoint of a virtual line segment connecting a hole center of the first hole 34a and a hole center of the second hole 34b when viewed on the cross section perpendicular to the longitudinal direction, and the lateral projections 34c extend in the longitudinal direction (a direction perpendicular to the sheet of FIG. 8). The two lateral projections 34c (the second regulator) are engaged with lateral grooves 73c (groove portion) of the cap holder 73 illustrated in FIG. 34. Therefore, the cap unit 34Y is attached to and detached from the cap holder 73 while the posture of the cap unit 34Y in the rotational direction is regulated, and also, the posture of the cap unit 34Y in the rotational direction is regulated during when the cap unit 34Y is attached to the cap holder 73.

More specifically, each tip of the lateral projections 34c has a tapered shape in the longitudinal direction (attachment direction) as illustrated in FIG. 11. When the cap unit 34Y is attached to the cap holder 73, the first engaging portion 34e is engaged with the engaged portion 73m first, and thereafter the second engaging portions 34f are engaged with the engaged portions 73m and the two lateral projections 34c having tapered shapes are engaged with the lateral grooves 73c, so that the cap unit 34Y can be smoothly attached to the cap holder 73 while the posture of the cap unit 34Y is securely regulated.

Referring to FIGS. 11 and 12, the RFID chip 35, which is an electronic-information storage member for storing various types of electronic information, is mounted on a mount portion 34k (surrounded by a convex portion) formed between the first hole 34a and the second hole 34b on the end face of the cap unit 34Y. The RFID chip 35 is arranged so as to face the antenna 73e of the cap holder 73 at a predetermined distance when the cap unit 34Y is attached to the toner-container holder 70 (the cap holder 73). The RFID chip 35 performs non-contact communication (radio communication) with the antenna 73e while the cap unit 34Y is being held by the cap holder 73.

In the first embodiment, because the RFID chip 35 is fixed between the first hole 34a (main guide hole) and the second hole 34b (sub-guide hole), the position of the RFID chip 35 relative to the antenna 73e of the cap holder 73 can be fixed with high accuracy. Therefore, it is possible to prevent a communication fault due to positional deviation of the RFID chip 35 from the antenna 73e (RFID antenna).

The protrusion 34e1 and projections 34m are arranged so as to protrude further toward the front face side (right side in FIG. 25) than the convex portion (rib) formed on the circumference of the mount portion 34k. Therefore, even when the toner container 32Y is placed with the container body 33Y side up and the cap unit 34Y side down, it is possible to prevent the RFID chip 35 held in the mount portion 34k from coming into direct contact with a placement surface of the cap holder 73, thereby preventing the RFID chip 35 from being damaged.

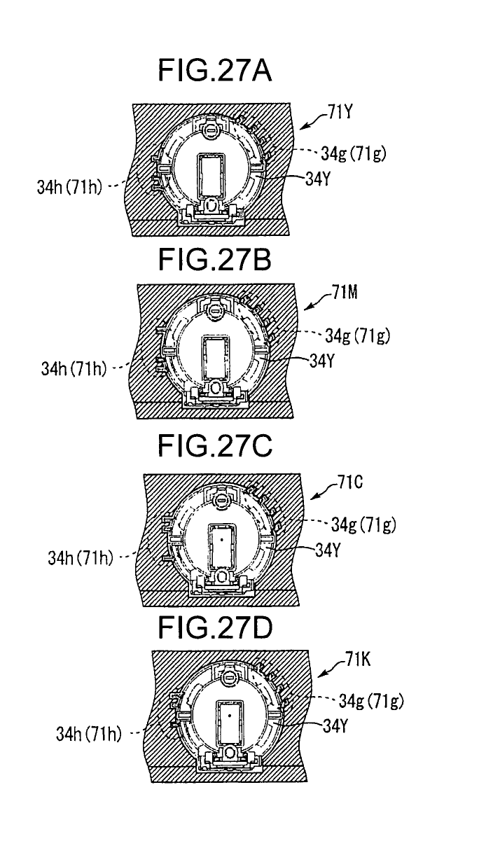

Referring to FIGS. 11 and 12, convex portions 34g and 34h for ensuring the incompatibility of the toner container 32Y with toner containers of other colors are formed on the outer circumferential surface of the cap unit 34Y. The convex portions 34g and 34h are configured to be engaged with corresponding engagement members 71 g and 71 h (formed on the insertion port 71 of the toner-container holder 70, see FIGS. 27A to 27D) when the attachment operation of the toner container 32Y to the toner-container holder 70 is correctly performed (when the toner container 32Y is attached to a correct position in the toner-container holder 70).

Specifically, referring to FIGS. 27A to 27D, the convex portions 34g and 34h are arranged at different positions depending on each color of toner contained in the toner container (container body). The convex portions 34g and 34h corresponding to the toner container for cyan are formed at the positions at which the convex portions 34g and 34h can be engaged with only the engagement members 71 g and 71 h for cyan in the toner-container holder 70 (the insertion port 71C) (see FIG. 27C), the convex portions 34g and 34h corresponding to the toner container for magenta are formed at the positions at which the convex portions 34g and 34h can be engaged with only the engagement members 71g and 71h for magenta in the toner-container holder 70 (the insertion port 71M) (see FIG. 27B), the convex portions 34g and 34h corresponding to the toner container for yellow are formed at the positions at which the convex portions 34g and 34h can be engaged with only the engagement members 71g and 71h for yellow in the toner-container holder 70 (the insertion port 71Y) (see FIG. 27A), and the convex portions 34g and 34h corresponding to the toner container for black are formed at the positions at which the convex portions 34g and 34h can be engaged with only the engagement members 71g and 71h for black in the toner-container holder 70 (the insertion port 71K) (see FIG. 27D).

With the above configurations, it is possible to prevent a toner container for a certain color (for example, a toner container for yellow) from being set in a toner-container holder for a different color (for example, a toner-container holder for cyan), thereby preventing a failure to form a desired color image. That is, it is possible to prevent the toner container from being erroneously set in the toner-container holder.

Some of the incompatible convex portions 34g and 34h are cut off depending on the type (color) of toner contained in the toner container in order to fulfill the incompatible function for each color. That is, necessary claw portions are cut off with a cutting tool, such as a nipper or a cutter, from the cap unit 34Y having the incompatible convex portions 34g and 34h (eight claw members are formed on the left and right sides in total as illustrated in FIG. 8), so that the incompatible convex portions 34g and 34h of various shapes can be formed (in the first embodiment, four types are formed as illustrated in FIGS. 27A to 27D.

With the above configuration, it is not necessary to manufacture the same number of molds as the number of types of the toner containers (cap units), and it is possible to form a plurality of types of incompatible cap units by using one mold. Therefore, it is possible to reduce the entire manufacturing costs for the plurality of types of the toner containers.

In the first embodiment, the four types of incompatible cap units illustrated in FIGS. 27A to 27D are formed. However, it is possible to further form a plurality of types of incompatible cap units by cutting off necessary claw portions with various combinations thereof from the eight claw portions of the incompatible convex portions 34g and 34h (eight claw members are formed on the left and right sides in total).

Referring to FIG. 12, the notch portion 34x, at which a part of the gear 33c of the container body 33Y is exposed, is formed on the outer circumferential surface of the cap unit 34Y. While the toner container 32Y is being attached to the toner-container holder 70, the gear 33c exposed through the notch portion 34x of the cap unit 34Y is engaged with the driving gear 81 (disposed at a position indicated by a dashed-dotted line in FIG. 34, though the details are not illustrated) arranged in the cap holder 73, so that the driving gear 81 rotates the container body 33Y with the gear 33c together.

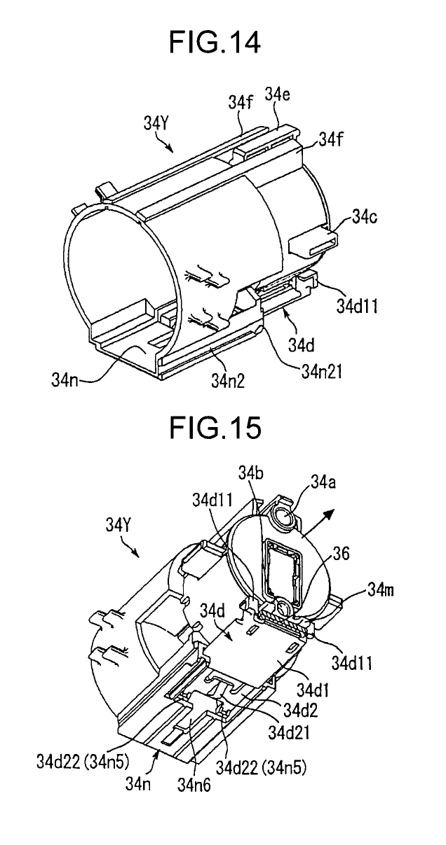

Referring to FIGS. 13 and 14, a shutter housing unit 34n (housing unit) is formed at the bottom portion of the cap unit 34Y in order to house a part of the shutter unit 34d (the deformable shutter member 34d2) when the shutter unit 34d opens the toner outlet W. The shutter housing unit 34n is a space having an approximately rectangular parallelepiped shape bulging downward from the insertion portion 34z. The shutter housing unit 34n (housing unit) houses the deformable shutter member 34d2 by maintaining a deformed state (state in which the deformable shutter member 34d2 is elastically deformed upward by using the connection position of a shutter main unit 34d1 as a base point). Note that shutter housing unit 34n which includes the contact portion 34n5 houses the deformable shutter member 34d2, but according to an embodiment does not house the slidable shutter 34d1 Referring to FIGS. 11 and 12, shutter rails 34t (see FIG. 19) and slide grooves 34n1, which function as a rail unit for guiding the open/close operation of the shutter unit 34d, are formed on the inner surface of the shutter housing unit 34n. The configuration and operation of the shutter unit 34d will be described in detail below.

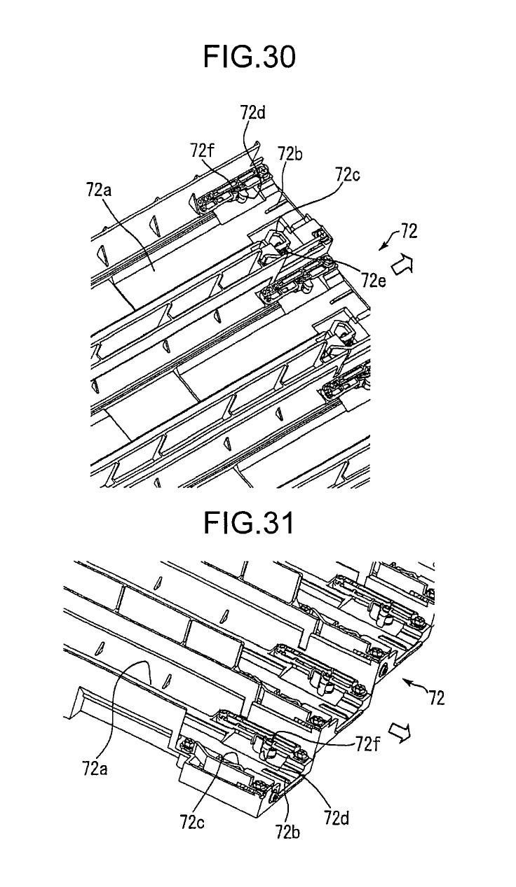

Referring to FIG. 12, a pressing rail 34n2 is formed on one side of the outer circumferential surface of the shutter housing unit 34n. The pressing rail 34n2 is engaged with a pressing member 72c of the bottle holder 72 (see FIGS. 30 and 38) in order to fix the position of the cap unit 34Y passing through the bottle holder 72 when the toner container 32Y is attached to/detached from the toner-container holder 70. The pressing rail 34n2 is formed as a concave shape (a groove), and is arranged in parallel to the attachment direction (the longitudinal direction) of the toner container 32Y. The pressing rail 34n2 is formed along the longitudinal direction (attachment/detachment direction) throughout the shutter housing unit 34n. Both ends of the pressing rail 34n2 are kept open without providing wall portions. A tapered portion 34n21 is formed at the tip of the pressing rail 34n2 in the attachment direction for smooth engagement of the pressing member 72c with the pressing rail 34n2 in the attachment operation.

Referring to FIG. 11, a pressure receiving face 34n3 is formed on the other side of the outer circumferential surface of the shutter housing unit 34n. A pressure receiving member 72d of the bottle holder 72 (see FIGS. 30 and 38) comes into slide contact with the pressure receiving face 34n3 in order to fix the position of the cap unit 34Y that passes through the bottle holder 72 when the toner container 32Y is attached to/detached from the toner-container holder 70.

With the above configuration, when the cap unit 34Y is just before (or just after) being attached to (or detached from) the cap holder 73 in the attachment (or detachment) operation of the toner container 32Y to (or from) the toner-container holder 70, in the cap unit 34Y, the pressing rail 34n2 is engaged with and urged by the pressing member 72c that is urged by a compression spring 72e, so that the pressure receiving face 34n3 receives the urging force while coming into slide contact with the pressure receiving member 72d. In this manner, the posture of the cap unit 34Y just before (or just after) being attached to (or detached from) the cap holder 73 is regulated when passing through the bottle holder 72.

The cap unit 34Y configured as above is connected with the container body 33Y via the opening A, and discharges toner discharged from the opening A from the toner outlet W (the movement in the direction indicated by the dashed arrow in FIG. 3).

In the first embodiment, referring to FIG. 25, the cavity B (space) in an approximately cylindrical shape is formed inside the cap unit 34Y such that the cavity B extends in the longitudinal direction (a horizontal direction in FIG. 25). The inner diameter of the cavity B is smaller than the inner diameter of the insertion portion 34z illustrated in FIG. 26 (a portion into which the head of the container body 33Y is inserted). A toner fall path C, which has a columnar shape with a constant flow passage area (cross-sectional area of the flow passage) from a lower circumferential surface of the approximately-cylindrical cavity B to the toner outlet W, is formed inside the cap unit 34Y. Therefore, toner that has been discharged from the opening A of the container body 33Y to the cavity B of the cap unit 34Y falls through the columnar toner fall path C by own weight and are smoothly discharged from the toner outlet W to the outside (the toner tank unit 61Y) of the container.

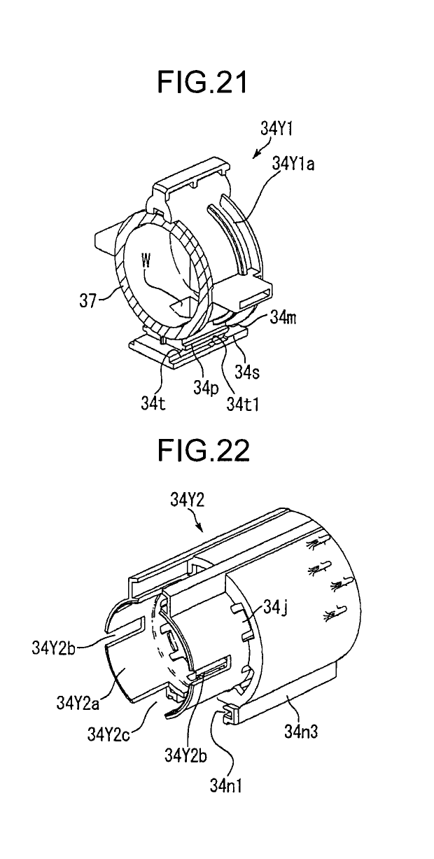

Referring to FIG. 19, the cap unit 34Y (the shutter unit 34d and the shutter seal 36 are removed and hence, not illustrated) is formed by welding a first member 34Y1 (see FIGS. 20 and 21) and a second member 34Y2 (see FIG. 22). More specifically, the lateral projections 34c and the bottom portion of the first member 34Y1 are fitted to notch portions 34Y2b and 34Y2c of the second member 34Y2, and an inner circumferential surface 34Y2a of the second member 34Y2 is fitted to and bonded (welded) to a bonding portion 34Y1a of the first member 34Y1.

As illustrated in FIGS. 20 and 21, the ring-shaped cap seal 37 as a seal member is attached to an opposing surface of the first member 34Y1 (a surface to face the bottle opening 33a formed on the circumference of the opening A of the container body 33Y). The cap seal 37 is used for sealing a gap between opposing surfaces of the container body 33Y and the cap unit 34Y at the circumference of the opening A, and is made of elastic material such as polyurethane foam (foamed resin material).

As illustrated in FIG. 20, the mount portion 34k for mounting the RFID chip 35 is formed on the end face of the first member 34Y1. The mount portion 34k is formed as a wall portion of which the circumference protrudes from the end face of the first member 34Y1. Base portions 34k2 for fixing four corners of the approximately-rectangular RFID chip 35 are formed at four corners of the rectangular wall portion inside the mount portion 34k. By placing the RFID chip 35 on the base portions 34k2, an electronic device formed on the back face of the RFID chip 35 (a surface to face the first member 34Y1) does not come into contact with the first member 34Y1. The RFID chip 35 is fixed to the mount portion 34k in such a manner that heat and pressure are applied to a part of the base portions 34k2 for fusing after the RFID chip 35 is placed on the base portions 34k2, and the base portions 34k2 are cooled to be solidified and joined to the four corners of the RFID chip 35.

As illustrated in FIGS. 20 and 21, the shutter rails 34t (rail unit) for guiding the shutter unit 34d to move in the longitudinal direction so as to open and close the toner outlet W is formed on both sides of the bottom portion of the first member 34Y1 (the cap unit 34Y). The shutter rails 34t are formed on two vertical surfaces 34s that stand upward from both side edges of the bottom surface on which the toner outlet W is formed. In other words, the shutter rails 34t are formed by using a part of the vertical surfaces 34s. The shutter rails 34t are formed by using upper surfaces of projections provided in a protruding manner at the both edges of the bottom surface (both edges in a direction perpendicular to the sheet of FIG. 25). The vertical surfaces 34s that stand upward are formed on the side edge portions of the projections. The two vertical surfaces 34s formed on both side edges of the first member 34Y1 extend from the end of the shutter unit 34d, which is at a position of closing the toner outlet W in the closing direction, to the protruding position in the longitudinal direction (attachment direction) (also see FIG. 39).

More specifically, two projections 34m (hornlike members) projecting in the longitudinal direction (attachment direction) from the end face of the cap unit 34Y perpendicular to the longitudinal direction are formed on the cap unit 34Y. The two projections 34m are disposed so as to sandwich the second hole 34b near a bottom edge of the second hole 34b. The two vertical surfaces 34s are configured to include respective vertical surfaces of the side edges of the two projections 34m. That is, the vertical surfaces at the outer edges of the two projections 34m are formed to be on the same planes as the vertical surfaces 34s on which the shutter rails 34t are formed.

The vertical surfaces 34s configured as above are held surfaces that are held by first holding members 73d1 of shutter closing mechanisms 73d (shutter holding mechanisms) of the cap holder 73 (the toner-container holder 70) (see FIG. 41). That is, the posture of the shutter unit 34d of the cap unit 34Y set in the cap holder 73 is fixed by the shutter closing mechanisms 73d that also function as the shutter holding mechanisms.

Because the vertical surfaces 34s that function as the held surfaces are extended in the attachment direction (to the upper direction in FIG. 41), when the toner container 32Y is removed from the toner-container holder 70, a timing at which the shutter closing mechanisms 73d (second holding members 73d2) release holding of the shutter unit 34d using the vertical surfaces 34s as references can be delayed as compared to a timing at which the shutter closing mechanisms 73d completely close the shutter unit 34d. Therefore, it is possible to prevent the toner container 32Y from being removed from the body of the image forming apparatus 100 before the shutter unit 34d completely closes the toner outlet W. In particular, because the tips of the two projections 34m in the longitudinal direction (attachment direction) are located to protrude relative to the end face of the first hole 34a in the longitudinal direction (attachment direction), the shutter closing mechanisms 73d (the second holding units 73d2) release holding of the shutter unit 34d at the end of removal of the cap unit 34Y from the cap holder 73. Therefore, it is possible to securely prevent a closing error of the shutter unit 34d. The configuration and operation of the shutter closing mechanisms 73d (the shutter holding mechanisms) will be described in detail below with reference to FIGS. 39 to 41.

The shutter unit 34d with the shutter seal 36 (seal member) attached on a surface to face the toner outlet W is disposed at the bottom portion of the cap unit 34Y configured as above. As illustrated in FIGS. 15 to 17, the shutter unit 34d opens and closes the toner outlet B in association with the attachment/detachment operation of the toner container 32Y to the toner-container holder 70.

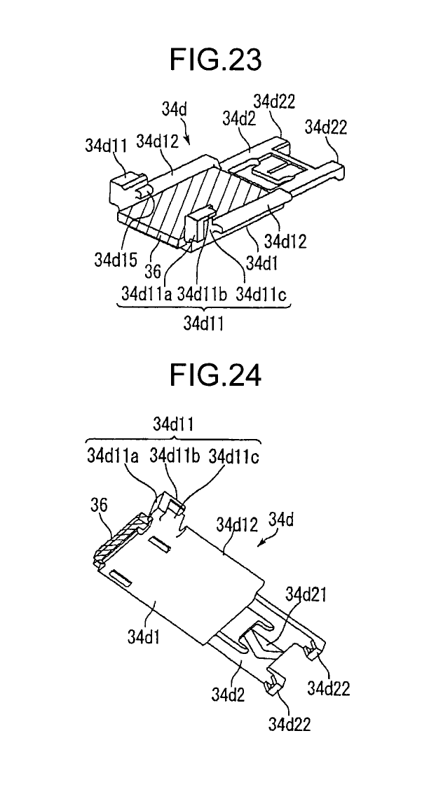

More specifically, referring to FIGS. 23 and 24, the shutter unit 34d includes a plate-shaped shutter main unit 34d1 and the deformable shutter member 34d2, protruding from the shutter main unit 34d1, that is thinner than the shutter main unit 34d1 and elastic. Shutter sliders 34d12 being a pair are formed on both outer sides of the shutter main unit 34d1, and shutter-rail engaging portions 34d15 being a pair are formed on both inner sides of the shutter main unit 34d1. The shutter sliders 34d12 are projections that extend on side portions of the shutter main unit 34d1 and parallel to the insertion direction of the toner container 32Y. The shutter-rail engaging portions 34d15 project inside the shutter main unit 34d1 (on the side opposite to the side where the shutter sliders 34d12 protrude) by keeping a predetermined distance from the shutter seal 36. The length of the shutter sliders 34d12 in the insertion direction of the toner container 32Y is set, in a state in which the shutter sliders 34d12 are assembled to the toner container 32Y, to be equal to the length between the end of one of the shutter rails 34t and one of convex portions 34t1 formed on the one of the shutter rails 34t. The length of each of the slide grooves 34n1 formed in the shutter housing unit 34n in the insertion direction is approximately equal to the length of each of the shutter sliders 34d12.

The shutter sliders 34d12 of the shutter main unit 34d1 are engaged with the slide grooves 34n1 (rail units) of the cap unit 34Y, and the shutter rails 34t (rail units) of the cap unit 34Y are engaged, by being sandwiched, with the shutter-rail engaging portions 34d15 and the shutter seal 36 of the shutter main unit 34d1. Therefore, the shutter main unit 34d1 opens and closes the toner outlet W by the movement of the shutter unit 34d along the rail units 34n1 and 34t.

The shutter seal 36 as a seal member is attached on the top face of the shutter main unit 34d1 (the surface to face the toner outlet W). The shutter seal 36 prevents toner from leaking between the shutter main unit 34d1 and the toner outlet W while the toner outlet W is being closed by the shutter main unit 34d1 (the shutter unit 34d). The shutter seal 36 is made of foamed resin material or the like.

As illustrated in FIGS. 23 and 24, the shutter seal 36 of the first embodiment is disposed so as to protrude in the longitudinal direction (attachment direction) from one end of the shutter unit 34d along the closing direction. The tip of the shutter seal 36 (protruding portion) comes into contact with a wall formed on the circumference of the toner supply port 73w (see FIG. 34) when the cap unit 34Y is attached to the cap holder 73, and functions as a seal member to prevent toner in the toner container 32Y from leaking to the periphery of the toner supply port 73w.

Referring to FIGS. 23 and 24, the deformable shutter member 34d2 of the shutter unit 34d is integrally formed on the shutter main unit 34d1 and is elastically deformable in the vertical direction by using the connection position between the deformable shutter member 34d2 and the shutter main unit 34d1 as a base point (a portion surrounded by a dashed circle in FIG. 18). The deformable shutter member 34d2 is disposed on the side of the container body 33Y in the longitudinal direction when compared to the shutter main unit 34d1 (see FIG. 15). Stoppers 34d22 and a stopper releasing unit 34d21 are formed on the deformable shutter member 34d2. The shutter unit 34d is a mechanism for sealing the opening, the shutter main unit 34d1 is a cover, and the deformable shutter member 34d2 is an extension. This extension 34d2 includes a pushing surface 34d21 and a blocking surface 34d22. There is a restriction 34n5 which contacts the blocking surface 34d22 to prevent the slidable shutter from sliding. The extension 34d2 along with the restriction 34n5 are an example of a means for restricting and permitting movement of the shutter.

The stoppers 34d22 of the deformable shutter member 34d2 are walls formed on the endmost portions (tips of the deformable shutter member 34d2 on the distant side from the shutter main unit 34d1) in the opening direction of the deformable shutter member 34d2 (the left side in FIG. 18). The stoppers 34d22 come into contact with contact portions 34n5 formed on the shutter housing unit 34n of the cap unit 34Y, thereby regulating the motion of the shutter unit 34d in a direction from the toner outlet W being closed to open. That is, the stoppers 34d22 of the shutter unit 34d are in contact with the contact portions 34n5 while the toner container 32Y remains isolated (when the toner container 32Y is not set in the body of the image forming apparatus 100), so that the shutter unit 34d does not move by itself in the opening direction to open the toner outlet W.

The stopper releasing unit 34d21 (stopper releasing projection) of the deformable shutter member 34d2 protrudes downward in the vertical direction. The stopper releasing unit 34d21 displaces the stoppers 34d22 upward along with upward elastic deformation of the deformable shutter member 34d2 upon receiving an external force from below, thereby releasing the state of contact between the stoppers 34d22 and the contact portions 34n5. The stopper releasing unit 34d21 is formed between the stoppers 34d22 and the connection position (connection position between the shutter main unit 34d1 and the deformable shutter member 34d2), and is a ridge-shaped projection with slopes formed on both sides along the longitudinal direction. The stopper releasing unit 34d21 comes into contact with a stopper-release biasing portion 72b (see FIGS. 28 and 38), which is formed on the bottle holder 72, in association with the attachment operation of the toner container 32Y to the toner-container holder 70, and is pushed upward by the stopper-release biasing portion 72b (receives an external force from below). Then, the deformable shutter member 34d2 is elastically deformed upward and accordingly, the stoppers 34d22 are displaced upward. Thus, the contact state between the stoppers 34d22 and the contact portions 34n5 is released, so that the shutter unit 34d can move in the opening direction.

Referring to FIGS. 18A to 18C, the operation of the shutter unit 34d in association with the attachment operation of the toner container 32Y to the toner-container holder 70 will be described in detail below. The positions of the shutter unit 34d in FIGS. 18A to 18C correspond, respectively, to the positions of the shutter unit 34d in FIGS. 15 to 17.

As illustrated in FIG. 18A, when the attachment operation of the toner container 32Y to the toner-container holder 70 (movement to the right in FIGS. 18A to 18C) is started yet the stopper releasing unit 34d21 of the shutter unit 34d has not reached the position of the stopper-release biasing portion 72b formed on the bottle holder 72 (also see FIGS. 28 and 38), the stoppers 34d22 of the shutter unit 34d are in contact with the contact portions 34n5 and the motion of the shutter unit 34d in the opening direction is regulated. As illustrated in FIG. 18B, when the attachment operation of the toner container 32Y proceeds, the stopper releasing unit 34d21 is pushed upward by the stopper-release biasing portion 72b, and the deformable shutter member 34d2 is elastically deformed by using the connection position (a portion surrounded by a dashed circle) as a base point. Accordingly, the contact state between the stoppers 34d22 and the contact portions 34n5 is released and the shutter unit 34d is allowed to relatively move in the opening direction.

Thereafter, the shutter unit 34d comes into contact with the wall formed on the circumference of the toner supply port 73w of the cap holder 73 (see FIG. 34), so that the motion of the shutter unit 34d in the toner-container holder 70 (the cap holder 73) is regulated (the shutter unit 34d does not move in the longitudinal direction at all). However, the toner container 32Y is allowed to move in the attachment direction, so that the shutter unit 34d relatively moves in the opening direction. That is, as illustrated in FIG. 18C, the shutter unit 34d relatively moves to the side of the container body 33Y and the deformable shutter member 34d2 is housed in the shutter housing unit 34n (housing unit). Thus, the opening process of the toner outlet W is completed by the movement of the shutter unit 34d in the opening direction. At this time, the stopper releasing unit 34d21 of the shutter unit 34d is stored in a notch portion 34n6 of the shutter housing unit 34n (also see FIG. 17).

As described above, the toner container 32Y of the first embodiment includes, on the shutter unit 34d, the deformable shutter member 34d2 that is elastically deformed by using the connection position of the shutter main unit 34d1 as a base point, and also includes, on the deformable shutter member 34d2, the stoppers 34d22 for regulating the motion of the shutter unit 34d in the opening direction and the stopper releasing unit 34d21 for releasing the regulation. Therefore, the shutter unit 34d does not open the toner outlet W by itself while the toner container 32Y remains isolated. Instead, the shutter unit 34d opens the toner outlet W in association with the attachment operation only when the toner container 32Y is set in the body of the image forming apparatus 100.

The shutter-rail engaging portions 34d15 of the shutter main unit 34d1 (see FIG. 23) also function as second stoppers that come into contact with a second contact portion formed on the cap unit 34Y (a portion surrounded by a dashed circle in FIGS. 19 and 20) and regulate a motion of the shutter unit 34d in a closing direction (the opposite direction of the direction in which the stoppers 34d22 perform regulation). That is, when the shutter unit 34d transits from the state in which the toner outlet W is open (the state illustrated in FIG. 17) to the state in which the toner outlet W is closed (the state illustrated in FIG. 15), the shutter-rail engaging portions 34d15 (the second stoppers) of the shutter unit 34d come into contact with the second contact portion (the portion surrounded by the dashed circle in FIGS. 19 and 20) on the trailing side in the closing direction, and the stoppers 34d22 of the shutter unit 34d come into contact with the contact portions 34n5 on the leading side in the closing direction. Accordingly, the position of the shutter unit 34d in the closed state is fixed. At this time, the shutter-rail engaging portions 34d15 of the shutter unit 34d come into contact with the second contact portion just after passing over the convex portions 34t1 formed on the shutter rails 34t (see FIGS. 20 and 21), so that it is possible to gain a click feeling in closing the shutter unit 34d.

Referring to FIGS. 19 to 21, ribs 34p having vertical surfaces on the same virtual planes as the vertical surfaces 34s of the shutter rails 34t (or vertical surfaces parallel to the virtual plane) are extended on the upper sides of the shutter rails 34t in the longitudinal direction while groove portions are interposed between the ribs 34p and the shutter rails 34t. The ribs 34p prevent the first holding members 73d1 from entering the groove portions on the upper sides of the shutter rails 34t when the first holding members 73d1 of the shutter closing mechanisms 73d (shutter holding mechanisms) illustrated in FIG. 41 hold the vertical surfaces 34s of the shutter rails 34t. That is, a distance between one of the ribs 34p and one of the shutter rails 34t on the same side of the first member 34Y1 between the two elements of the ribs 34p and the shutter rails 34t (a distance of the groove portion) is set to be shorter than the heights of the first holding members 73d1 (the lengths in a direction perpendicular to the sheet of FIG. 41).

The ribs 34p can fulfill the functions as long as the ribs 34p laterally protrude (in the direction perpendicular to the sheet of FIG. 25) and extend in the longitudinal direction (the horizontal direction in FIG. 25). Therefore, the ribs 34p do not necessarily have the vertical surfaces described above.

Referring to FIGS. 23 and 24, held portions or protrusions 34d11 being a pair are formed on the attachment direction's side of the tips on both sides of the edges of the shutter main unit 34d1 of the shutter unit 34d. These held portions or protrusions may be considered a means for moving the shutter. As illustrated in FIGS. 39 to 41, the held portions 34d11 are held by the second holding members 73d2 of the shutter closing mechanisms 73d (shutter holding mechanisms) at the time of the open/close operation of the shutter unit 34d. Each of the held portions 34d11 is formed of an engaging wall 34d11a that stands on the tip of the shutter main unit 34d1 in the attachment direction, a suppression wall 34d11b extending on the upper side of the held portion 34d11 to be parallel to the attachment direction, and a side wall 34d11c (which also functions as a side wall of the shutter main unit 34d1).

The held portions 34d11 of the shutter unit 34d are held by the second holding members 73d2 of the shutter closing mechanisms 73d (shutter holding mechanisms) and the vertical surfaces 34s of the cap unit 34Y are held by the first holding members 73d1 of the shutter closing mechanisms 73d (shutter holding mechanisms) at the time of the open/close operation of the shutter unit 34d. Accordingly, the postures of the shutter unit 34d and the cap unit 34Y in the cap holder 73 during the open/close operation of the shutter unit 34d can be fixed. At this time, the second holding members 73d2 of the shutter closing mechanisms 73d (shutter holding mechanisms) hold the side walls 34d11c of the held portions 34d11 (the shutter main unit 34d1), and the suppression walls 34d11b function to suppress vertical motion of the held portions 34d11 relative to the second holding members 73d2. The engaging walls 34d11a of the held portions 34d11 are engaged with the second holding members 73d2, which will be described later. The shutter closing mechanism 73 in its entirety, or just the second holding member 73d2 may be considered a movable catch.

Referring to FIGS. 17 and 41, the toner outlet W of the cap unit 34Y, which is opened and closed by the shutter unit 34d configured as above, has a hexagonal shape when viewed from below in the vertical direction.

More specifically, an edge portion 34r protruding downward is formed on the circumference of the toner outlet W of the cap unit 34Y. The edge portion 34r has vertex portions 34r1 on both sides in the longitudinal direction (the vertical direction in FIG. 41). Each of the tips 34r1 has a pointed shape that is pointed in a longitudinal direction to be separated from the center of the toner outlet W. More specifically, when viewed from below in the vertical direction, the edge portion 34r is a hexagonal edge portion having parallel portions 34r2 that are opposed to each other along the longitudinal direction (the vertical direction in FIG. 41), and the two vertex portions 34r1 that are positioned on the tips opposing to each other in the longitudinal direction. The toner outlet W has a hexagonal shape that follows the hexagonal shape of the edge portion 34r.

In this manner, the tips 34r1, which are formed on the edge portion 34r on the circumference of the toner outlet W in the longitudinal direction (the direction in which the shutter unit 34d is opened and closed), have pointed shapes, so that when the shutter unit 34d is closed, the shutter seal 36 attached to the shutter unit 34d first comes into slide contact with the edge portion 34r at the pointed-shaped vertex portion 34r1 with a small area, and thereafter, the area of the slide contact gradually increases. Therefore, the shutter seal 36 is less likely to be peeled off or damaged due to the contact with the edge portion 34r. When the shutter unit 34d is opened, the area of the slide contact gradually decreases, so that the damage on the shutter seal 36 due to the contact with the edge portion 34r is reduced.

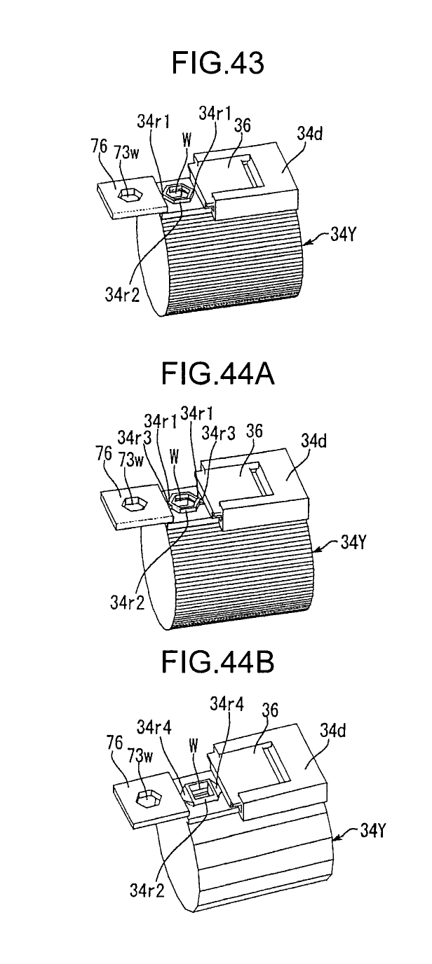

Referring to FIG. 43, a seal member 76 made of foamed resin material is attached to the circumference of the toner supply port 73w of the cap holder 73 (also see FIG. 38), so that it is possible to prevent toner from scattering from the toner supply port 73w connected with the toner outlet W of the toner container 32Y. Even when the edge portion 34r of the cap unit 34Y comes into slide contact with the seal member 76 arranged on the circumference of the toner supply port 73w in association with the attachment operation of the toner container 32Y in the longitudinal direction, the edge portion 34r comes into slide contact with the seal member 76 first at the pointed-shaped vertex portion 34r1 with a small area, and thereafter, the area of the slide contact gradually increases. Therefore, the seal member 76 of the toner supply port 73w is less likely to be peeled off or damaged due to the contact with the edge portion 34r. In addition, when the detachment operation of the toner container 32Y in the longitudinal direction is performed, the area of the slide contact between the seal member 76 of the toner supply port 73w and the edge portion 34r gradually decreases, so that damage on the seal member 76 of the toner supply port 73w due to the contact with the edge portion 34r can be reduced. In FIG. 43, the positional relationship between the seal member 76 of the toner supply port 73w and the toner outlet W is illustrated in a vertically reversed manner for the sake of easy understanding.

Therefore, it is possible to securely prevent toner (or remaining toner) housed in the toner container 32Y from scattering to outside in association with the attachment/detachment operation of the toner container 32Y to/from the body of the image forming apparatus 100.

Referring to FIG. 17, in the first embodiment, the edge portion 34r of the cap unit 34Y is configured such that planes (planes in contact with the vertex portions 34r1) perpendicular to the longitudinal direction (the vertical direction in FIG. 41) have tapered shapes so that the amount of downward protrusion gradually decreases as the distance from the center of the toner outlet W increases.

With this configuration, even when the shutter seal 36 attached to the shutter unit 34d is rubbed by the edge portion 34r in association with the attachment/detachment operation of the toner container 32Y in the longitudinal direction, the shutter seal 36 is less likely to be damaged. Similarly, even when the seal member 76 (see FIG. 43) arranged on the circumference of the toner supply port 73w of the cap holder 73 is rubbed by the edge portion 34r in association with the attachment/detachment operation of the toner container 32Y in the longitudinal direction, the seal member 76 is less likely to be damaged.

Denoting, respectively, the volume-average particle size and the number-average particle size of toner contained in the toner containers 32Y, 32M, 32C, and 32K by Dv (μm) and Dn (μm), the toner used in the first embodiment is manufactured so that the following conditions are satisfied.

3≦Dv≦8 (1)

1.00≦Dv/Dn≦1.40 (2)

Therefore, toner particles suited for an image pattern are selected in a developing process to maintain good image quality, and, even when the toner is stirred in the developing device for a long period of time, good developing capability can be maintained. Furthermore, toner can be efficiently and securely conveyed without blocking the toner supply path such as a tube 75.

The volume-average particle size and the number-average particle size of toner are measured by using, for example, Coulter-counter particle size distribution measurement device such as “COULTER COUNTER TA-2” (Beckman Coulter, Inc.) or “COULTER MULTISIZER 2” (Beckman Coulter, Inc.).

In the first embodiment, as the toner contained in the toner containers 32Y, 32M, 32C, and 32K, approximately spherical toner with a shape factor SF-1 in a range from 100 to 180 and with a shape factor SF-2 in a range from 100 to 180 is used. Therefore, it is possible to maintain high transfer efficiency and prevent reduction in cleaning performance. In addition, toner can be efficiently and securely conveyed without blocking the toner supply path such as the tube 75.

The shape factor SF-1 represents the degree of sphericity of a toner particle, and is obtained by the following equation:

SF-1=(M²/S)×(100π/4).

In the above equation, M is the maximum particle size in a projection plane of the toner particle (the largest particle size among various particle sizes), and S is an area of the projection plane of the toner particle. Therefore, a toner particle with the shape factor SF-1 of 100 is perfectly spherical, and the sphericity decreases as the shape factor becomes greater than 100.

The shape factor SF-2 represents the irregularity of a toner particle, and is determined by the following equation:

SF-2=(N²/S)×(100/4π).

In the equation, N is the circumferential length in the projection plane of the toner particle, and S is an area of the projection plane of the toner particle. Therefore, a toner particle with the shape factor SF-2 of 100 has no irregularities, and the irregularity increases as the shape factor becomes greater than 100.

The shape factor SF-1 and the shape factor SF-2 are obtained by photographing toner particles by using a scanning electron microscope “S-800” (manufactured by Hitachi, Ltd.) and analyzing the obtained photograph of the toner particles by an image analyzer “LUSEX3” (manufactured by Nireco Corporation).

The toner-container holder 70 (the bottle holder 72 and the cap holder 73) will be described in detail below with reference to FIGS. 28 to 42.

As described above with reference to FIG. 4, the toner-container holder 70 includes the bottle holder 72, the cap holder 73, and the insertion port 71. The toner container 32Y is attached to the toner-container holder 70 from the insertion port 71 in the longitudinal direction as the attachment direction with the cap unit 34Y positioned at the leading end of the container body 33Y, while being kept by a user gripping the gripper 33d such that the longitudinal direction of the toner container 32Y is parallel to the horizontal direction. The toner container 32Y inserted from the insertion port 71 is pushed into the cap holder 73 by the user while sliding on the bottle holding face 72a of the bottle holder 72 (see FIGS. 30 and 31). Referring to FIGS. 28 and 29, bottle holding faces 72aY, 72aM, 72aC, and 72aK are formed on the bottle holder 72 for the respective colors, and the toner containers 32Y, 32M, 32C, and 32K are inserted to the respective bottle holding faces (in a direction indicated by an outlined arrow). Referring to FIG. 33, bottle holders 73Y, 73M, 73C, and 73K are formed on the cap holder 73 for the respective colors. The toner containers 32Y, 32M, 32C, and 32K are inserted in the respective bottle holders (in a direction indicated by an outlined arrow), so that each of the cap units 34Y, 34M, 34C, and 34K is non-rotatably held at the inserted position.

Referring to FIGS. 28 to 32, the bottle holder 72 of the toner-container holder 70 includes the bottle holding face 72a, the stopper-release biasing portion 72b, the pressing member 72c, the pressure receiving member 72d, the compression spring 72e, and a torsion coil spring 72f.

The bottle holding face 72a functions as a sliding face of the toner container 32Y during the attachment/detachment operation of the toner container 32Y, and functions as a holding unit of the rotatable container body 33Y after setting of the toner container 32Y is completed.

Referring to FIG. 29, the stopper-release biasing portion 72b is a trapezoidal rib formed on the upper side (trailing side in the attachment direction of the toner container 32Y) of the bottle holding face 72a. As described above with reference to FIG. 18, the stopper-release biasing portion 72b pushes the stopper releasing unit 34d21 of the shutter unit 34d upward to release the contact state between the stoppers 34d22 and the contact portions 34n5 in association with the attachment operation of the toner container 32Y (in order to enable the opening operation of the shutter unit 34d).

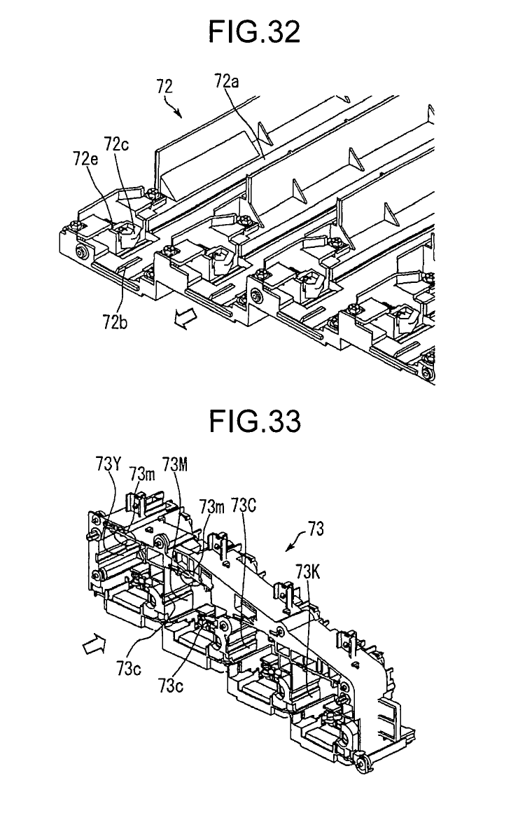

Referring to FIG. 29, the pressing member 72c is disposed on a side wall on the right side of the bottle holding face 72a on the downstream side in the attachment direction of the toner container 32Y. As illustrated in FIGS. 30 and 32, the tip of the pressing member 72c is formed to have a ridge shape, and the bottom portion of the pressing member 72c is connected to one end of the compression spring 72e. The pressing member 72c configured as above is urged by the compression spring 72e to the left in FIG. 29.

Referring to FIG. 29, on the other hand, the pressure receiving member 72d is disposed on a side wall on the left side of the bottle holding face 72a (the position to face the pressing member 72c) on the trailing side in the attachment direction of the toner container 32Y. As illustrated in FIG. 31, the tip of the pressure receiving member 72d is formed such that two curves form a reversed V-shape (the v-shaped cleavage faces diagonally the lower right side in FIG. 29), and the bottom portion of the pressure receiving member 72d is connected to the torsion coil spring 72f. The pressure receiving member 72d is oscillatory movable about a shaft portion where the coil portion of the torsion coil spring 72f is inserted.

With the pressing member 72c and the pressure receiving member 72d configured as above, the position of the cap unit 34Y just before being inserted to the cap holder 73 is fixed when the toner container 32Y is attached to the toner-container holder 70. More specifically, the pressing rail 34n2 of the cap unit 34Y (see FIG. 12) is engaged with the pressing member 72c, so that the cap unit 34Y is pressed by the pressing member 72c to the left in FIG. 29. The pressure receiving face 34n3 (see FIG. 11) of the cap unit 34Y pressed by the pressing member 72c comes into slide contact with the pressure receiving member 72d by which the pressing force is received to fix the position of the cap unit 34Y in the horizontal direction in FIG. 29.

Referring to FIGS. 33 to 37, the cap holder 73 of the toner-container holder 70 includes the main guide pin 73a, the sub-guide pin 73b, the engaged portion 73m, the lateral grooves 73c, the shutter closing mechanisms 73d (the shutter holding mechanisms), the toner supply port 73w, evacuation holes 73k, the antenna 73e (RFID antenna), and the driving gear 81.

As described above with reference to FIG. 11, the main guide pin 73a and the sub-guide pin 73b are engaged with the first hole unit 34a and the second hole unit 34b of the cap unit 34Y, respectively. Accordingly, the position of the cap unit 34Y in the cap holder 73 is fixed. Referring to FIG. 37, the main guide pin 73a is longer than the sub-guide pin 73b in the longitudinal direction (positions of the guide surfaces that function as the base portions are formed on the plane that is common to the main guide pin 73a and the sub-guide pin 73b). The tip of the main guide pin 73a is formed to be tapered. Therefore, it is possible to smoothly attach the toner container 32Y to the cap holder 73 in the attachment operation of the toner container 32Y to the cap holder 73 in the longitudinal direction.

The engaged portion 73m is engaged with the first engaging portion 34e and the second engaging portions 34f (regulator) formed on the cap unit 34Y of the toner container 32Y. Therefore, the cap unit 34Y is attached to and detached from the cap holder 73 while the posture of the cap unit 34Y in the horizontal direction is regulated. The lateral grooves 73c are engaged with the lateral projections 34c (second regulator) formed on the cap unit 34Y of the toner container 32Y. Therefore, the cap unit 34Y is attached to and detached from the cap holder 73 while the posture of the cap unit 34Y in the rotational direction is regulated. Furthermore, the posture of the cap unit 34Y in the rotational direction is regulated while the cap unit 34Y is being attached to the cap holder 73.

Referring to FIGS. 34 and 38, the shutter closing mechanisms 73d (shutter holding mechanisms) are disposed at the bottom position inside the cap holder 73, and on the leading side of the toner supply port 73w in the attachment direction of the toner container 32Y. The shutter closing mechanisms 73d being a pair are approximately horseshoe-shaped members that are arranged to face each other in the horizontal direction in FIG. 39, and are configured to be rotatable about supporting shafts 73d3 at which torsion coil springs are arranged. The first holding members 73d1 are formed on one end of the respective shutter closing mechanisms 73d (shutter holding mechanisms), and the second holding members 73d2 are formed on the other ends of the shutter closing mechanisms 73d. As described above, the held portions 34d11 of the shutter unit 34d are held by the second holding members 73d2 and the vertical surfaces 34s of the cap unit 34Y are held by the first holding members 73d1 during the open/close operation of the shutter unit 34d in the toner container 32Y, so that the postures of the shutter unit 34d and the cap unit 34Y in the cap holder 73 are fixed during the open/close operation of the shutter unit 34d. Consequently, it is possible to smoothly perform the open/close operation.

FIGS. 39 to 41 are diagrams illustrating the operation of the shutter closing mechanisms 73d (shutter holding mechanisms) in association with the open/close operation of the shutter unit 34d. As illustrated in FIG. 39, when the opening operation of the shutter unit 34d is performed, the first holding members 73d1 come into contact with the projections 34m and the second holding members 73d2 come into contact with the held portions 34d11 of the shutter unit 34d in association with the attachment operation of the toner container 32Y in the direction indicated by an outlined arrow.

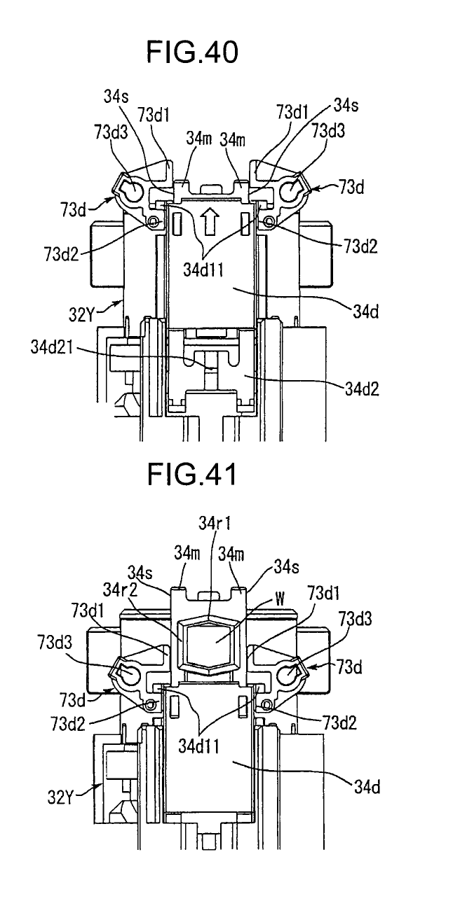

Thereafter, as illustrated in FIG. 40, when the attachment operation of the toner container 32Y in the direction indicated by the outlined arrow proceeds, the shutter closing mechanisms 73d (shutter holding mechanisms) rotate about the supporting shafts 73d3, so that the first holding members 73d1 hold the vertical surfaces 34s of the projections 34m of the cap unit 34Y and the second holding members 73d2, while being engaged with the engaging walls 34d11a of the held portions 34d11 of the shutter unit 34d, hold the side walls 34d11c (the shutter unit 34d) of the shutter main unit 34d1 (the held portions 34d11).

Thereafter, the shutter unit 34d comes into contact with the wall formed on the circumference of the toner supply port 73w of the cap holder 73 (see FIG. 34). Accordingly, the motion of the shutter unit 34d in the cap holder 73 is regulated as the shutter unit 34d is sandwiched between the wall and the second holding members 73d2 (the shutter unit 34d never move in the longitudinal direction). However, because the movement of the toner container 32Y in the attachment direction proceeds, the shutter unit 34d relatively moves in the opening direction. That is, as illustrated in FIG. 41, the shutter unit 34d relatively moves toward the container body 33Y, thereby to open the toner outlet W. At this time, as illustrated in FIG. 41, the opening operation of the shutter unit 34d is performed while the first holding members 73d1 hold the vertical surfaces 34s of the cap unit 34Y and the second holding members 73d2, being engaged with the held portions 34d11 of the shutter unit 34d, hold the shutter unit 34d. Therefore, the postures of the shutter unit 34d and the cap unit 34Y in the cap holder 73 are fixed and the opening operation of the shutter unit 34d can be smoothly performed.

On the other hand, when the toner container 32Y is removed (detached) from the toner-container holder 70 (the cap holder 73), the operation is performed in reverse order of the attachment operation described above. That is, the operation of the shutter closing mechanisms 73d (shutter holding mechanisms) in association with the closing operation of the shutter unit 34d is performed in the order of FIGS. 41, 40, and 39.

Referring to FIG. 40, in the first embodiment, because the vertical surfaces 34s that function as the held surfaces to be held by the first holding members 73d1 extend in the attachment direction (in the upward direction in FIG. 40) (because the projections 34m are arranged), when the toner container 32Y is removed from the toner-container holder 70, a timing at which the shutter closing mechanisms 73d (the second holding members 73d2) release holding of the shutter unit 34d (the held portions 34d11) using the vertical surfaces 34s as references can be delayed as compared to a timing at which the shutter closing mechanisms 73d completely close the shutter unit 34d. That is, because the vertical surfaces 34s (the projections 34m) are formed to extend to protrude to the upper side in FIG. 40, when the closing operation of the shutter unit 34d is performed (relative movement of the shutter unit 34d from the state illustrated in FIG. 41 to the state illustrated in FIG. 40), rotation of the shutter closing mechanisms 73d as illustrated in FIG. 39 is prevented and the closing operation of the shutter unit 34d can be completed while the first holding members 73d1 are holding the vertical surfaces 34s of the projections 34m and the second holding members 73d2 are holding the held portions 34d11 of the shutter unit 34d. In other words, when the vertical surfaces 34s are not formed to extend to protrude to the upper side in FIG. 40, the first holding members 73d1 release the holding of the vertical surfaces 34s at an earlier timing and the shutter closing mechanisms 73d instantly rotate as illustrated in FIG. 39, and accordingly, the second holding members 73d2 also release the holding of the held portions 34d11 of the shutter unit 34d. Consequently, the shutter unit 34d cannot complete the closing operation.

As described above, according to the first embodiment, because the projections 34m are arranged on the cap unit 34Y, it is possible to prevent the toner container 32Y from being removed from the body of the image forming apparatus 100 before the shutter unit 34d completely closes the toner outlet W. Referring to FIGS. 34 and 35, the cap holder 73 has the evacuation holes 73k formed on wall surfaces thereof such that the projections 34m of the cap unit 34Y do not cause interference with the wall surface of the cap holder 73.

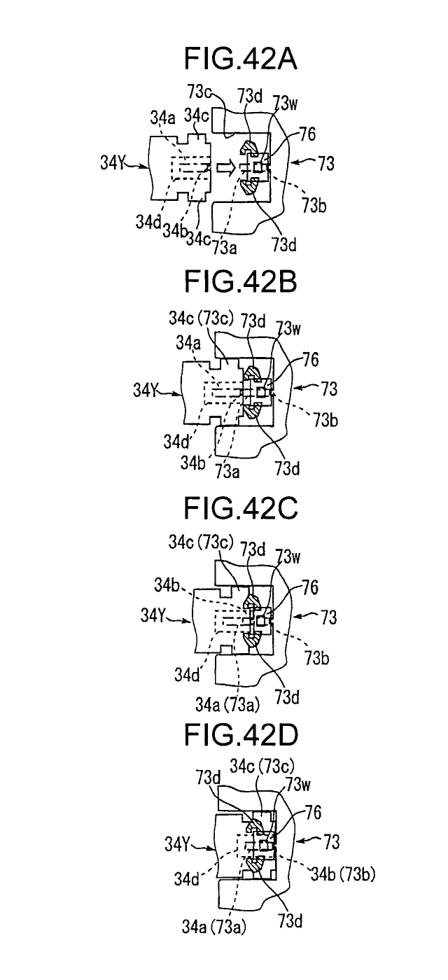

Referring to FIGS. 42A to 42D, when the attachment operation of the toner container 32Y to the toner-container holder 70 proceeds, each portion of the bottle holder 72 and the cap holder 73 is engaged with the cap unit 34Y in sequence as described below.

The cap unit 34Y slides on the bottle holding face 72a in the horizontal direction to be inserted to the cap holder 73. While sliding on the bottle holding face 72a, the backlash of the cap unit 34Y in the horizontal direction, which may occur immediately before being inserted to the cap holder 73, is reduced by the pressing member 72c and the pressure receiving member 72d. Thereafter, the first engaging portion 34e and the second engaging portions 34f of the cap unit 34Y are engaged with the engaged portion 73m of the cap holder 73, and the lateral projections 34c of the cap unit 34Y are engaged with the lateral grooves 73c of the cap holder 73, so that the posture of the cap unit 34Y in the cap holder 73 is regulated in both the vertical and horizontal directions (the state illustrated in FIG. 42A proceeds to the state illustrated in FIG. 42B). Subsequently, the first hole unit 34a of the cap unit 34Y is engaged with the main guide pin 73a of the cap holder 73, so that the position of the main guide is fixed (the state illustrated in FIG. 42C). Thereafter, the second hole unit 34b of the cap unit 34Y is engaged with the sub-guide pin 73b of the cap holder 73, so that the positions of the main guide and sub-guide are fixed. Before the positioning is completed (until the engagement of the second hole unit 34b with the sub-guide pin 73b is completed), the stopper-release biasing portion 72b releases the contact state between the stoppers 34d22 of the shutter unit 34d and the contact portions 34n5 in the cap unit 34Y. The shutter unit 34d starts the opening operation while the postures of the shutter unit 34d and the cap unit 34Y in the cap holder 73 are fixed by the shutter closing mechanisms 73d (the shutter holding mechanisms) (the state illustrated in FIG. 42C). In addition, until the engagement of the second hole unit 34b with the sub guide pin 73b is completed, the seal member 76 arranged on the circumference of the toner supply port 73w of the cap holder 73 and the edge portion 34r (the wall portion) formed on the circumference of the toner outlet W of the cap unit 34Y come into slide contact with each other. Accordingly, the toner outlet W that is opened in the cap unit 34Y and the toner supply port 73w of the cap holder 73 are connected with each other to complete the setting of the cap unit 34Y (the toner container 32Y) in the cap holder 73 (the toner-container holder 70) (the state illustrated in FIG. 42D). At this time, the gear 33c of the container body 33Y engages with the driving gear 81 of the image forming apparatus 100, and the RFID chip 35 of the cap unit 34Y is located at a position that is optimal to perform radio communication with the antenna 73e of the image forming apparatus 100.

In this manner, according to the first embodiment, because the postures of the shutter unit 34d and the cap unit 34Y in the cap holder 73 are fixed by the shutter closing mechanisms 73d (the shutter holding mechanisms) in the attachment operation of the toner container 32Y, it is possible to prevent the opening operation of the shutter unit 34d from being performed with the state in which the cap unit 34Y (the shutter unit 34d) is tilted.

In the attachment operation of the toner container 32Y, after the first hole 34a of the cap unit 34Y is engaged with the main guide pin 73a of the cap holder 73 to fix the position of the main guide, the postures of the shutter unit 34d and the cap unit 34Y in the cap holder 73 are fixed by the shutter closing mechanisms 73d (the shutter holding mechanisms). Thereafter, the second hole 34b of the cap unit 34Y is engaged with the sub-guide pin 73b of the cap holder 73 to fix the positions of the main guide and sub-guide. Therefore, the posture of the cap unit 34Y (the shutter unit 34d) can be corrected before the positioning of the cap unit 34Y to the sub-guide is completed.

Before the positioning of the main guide is completed by the engagement of the first hole 34a of the cap unit 34Y with the main guide pin 73a of the cap holder 73, the lateral projections 34c of the cap unit 34Y are engaged with the lateral grooves 73c of the cap holder 73, for example, to regulate the posture of the cap unit 34Y in the cap holder 73 in both the vertical and horizontal directions. Therefore, the cap unit 34Y can be smoothly positioned to the cap holder 73.

After the postures of the shutter unit 34d and the cap unit 34Y in the cap holder 73 are fixed by the shutter closing mechanisms 73d (the shutter holding mechanisms), the seal member 76 arranged on the circumference of the toner supply port 73w and the toner outlet W (the edge portion 34r) of the cap unit 34Y come into slide contact with each other, and thereafter the second hole 34b of the cap unit 34Y is engaged with the sub-guide pin 73b of the cap holder 73, so that the positions of the main guide and sub-guide are fixed. Therefore, the posture of the cap unit 34Y (the shutter unit 34d) can be corrected without receiving sliding contact resistance of the seal member 76.

In the first embodiment, because the shutter closing mechanism 73d (the shutter holding mechanism) is arranged near the sub-guide pin 73b and not near the main guide pin 73a, the postures of the shutter unit 34d and the cap unit 34Y in the cap holder 73 are easily corrected by the shutter closing mechanisms 73d (the shutter holding mechanisms).

In the detachment of the toner container 32Y, the first hole 34a of the cap unit 34Y is kept engaged with the main guide pin 73a of the cap holder 73 until the closing operation of the shutter unit 34d is completed after the engagement of the second hole 34b of the cap unit 34Y with the sub-guide pin 73b of the cap holder 73 is released. Therefore, it is possible to prevent the closing operation of the shutter unit 34d from being performed with the cap unit 34Y (the shutter unit 34d) being tilted.

As described above, according to the image forming apparatus of the first embodiment, by a user's single action of moving the toner container 32Y in the longitudinal direction while gripping the gripper 33d (excluding the open/close operation of a body cover 110), the open/close operation of the toner outlet W by the shutter unit 34d is also performed and the attachment/detachment operation of the toner container 32Y is completed.

The toner container 32Y of the first embodiment is disposed such that the toner outlet W with a relatively large opening area is arranged to be oriented downward in the vertical direction. Therefore, toner can efficiently be discharged directly from the toner outlet W by the toner's own weight.

The attachment and detachment of the toner container 32Y is performed from the front side of the toner-container holder 70 (the body of the image forming apparatus 100), not being performed from the upper side of the toner-container holder 70 (the body of the image forming apparatus 100). Therefore, flexibility in the layout of the upper side of the toner-container holder 70 is increased. For example, even when a scanner (a document read unit) is disposed above the toner supply devices, operability and workability are not deteriorated in the attachment and detachment of the toner container 32Y.

Furthermore, the toner container 32Y is set in the body of the image forming apparatus 100 with the longitudinal direction of the toner container kept horizontal, and hence, it is possible to increase the toner capacity of the toner container 32Y and to reduce the replacement frequency of the toner container 32Y without affecting the layout of the entire body of the image forming apparatus 100 in the height direction.

The characteristic configuration of the toner container 34Y according to the first embodiment will be summarized with reference to FIG. 43. As illustrated in FIG. 43, the edge portion 34r (wall portion) formed on the circumference of the toner outlet W of the cap unit 32Y has the vertex portions 34r1 on both the leading and trailing sides in the longitudinal direction. Each of the vertex portions 34r1 has a pointed shape. In addition, the edge portion 34r (especially the planes, other than the parallel portions 34r2, that are in contact with the vertex portions 34r1) of the cap unit 34Y is formed in a tapered shape inclined with respect to the vertical direction. With the above configuration, the shutter seal 36 of the shutter unit 34d and the seal member 76 provided on the circumference of the toner supply port 73w of the cap holder 73 smoothly come into slide contact with the edge portion 34r so as to gradually increase (or decrease) a contact area to the edge portion 34r in association with the attachment/detachment operation of the toner container 32Y in the longitudinal direction. Therefore, the shutter seal 36 and the seal member 76 are less likely to be peeled or damaged.

The shapes of the edge portion 34r and the toner outlet W are not limited to those in the first embodiment. For example, as illustrated in FIG. 44A, the vertex portions 34r1 of the edge portion 34r can be formed in tapered shapes so that the amount of downward protrusion gradually decreases from the center of the toner outlet W. More specifically, tapered portions 34r3 inclined with respect to the vertical direction can be formed on the vertex portions 34r1 of the edge portion 34r.

Alternatively, as illustrated in FIG. 44B, the toner outlet W can be formed in a rectangular shape while the outer circumference of the edge portion 34r is formed in the hexagonal shape. In addition, vertex portions 34r4 of the edge portion 34r can be formed in tapered shapes by being inclined with respect to the vertical direction. With both of the above configurations, similarly to the first embodiment, the shutter seal 36 of the shutter unit 34d and the seal member 76 provided on the circumference of the toner supply port 73w of the cap holder 73 smoothly come into slide contact with the edge portion 34r by gradually increasing (or decreasing) a contact area to the edge portion 34r in association with the attachment/detachment operation of the toner container 32Y in the longitudinal direction. Therefore, the shutter seal 36 and the seal member 76 are less likely to be peeled or damaged.

As described above, in the toner container 32Y according to the first embodiment, the shutter seal 36 (seal member) is provided on the surface of the shutter unit 34d that faces the toner outlet W, and each of the vertex portions 34r1 of the edge portion 34r is formed in a pointed shape so that the edge portion 34r provided on the circumference of the toner outlet W of the cap unit 34Y does not cause the shutter seal 36 to be peeled or damaged. Therefore, a space for arranging the toner container 32Y can be effectively secured in the body of the image forming apparatus 100 and the toner container 32Y can be set to the body of the image forming apparatus 100 with high fitting capability and operability, so that it is possible to prevent toner contained in the toner container 32Y from scattering to the outside of the toner container 32Y in association with attachment/detachment operation of the toner container 32Y to the body of the image forming apparatus 100 even when the toner container 32Y is configured to discharge toner from the toner outlet W by the toner's own weight.

The toner container described above is a toner container that is detachably attached to a body of an image forming apparatus with a longitudinal direction of the toner container being kept horizontal. The toner container includes a cylindrical container body, a cap unit, and a shutter unit. The cylindrical container body has an opening on one end thereof in the longitudinal direction, and is configured to convey toner contained therein toward the opening that is inserted to the cap unit. The cap unit includes a toner outlet at a bottom portion thereof for discharging toner, which has been discharged from the opening of the container body, to the outside of the toner container in a vertically downward direction. The shutter unit is held at the bottom portion of the cap unit and moves along an outer periphery of the cap unit to thereby open and close the toner outlet. The shutter unit includes a seal member on a surface facing the toner outlet, and the cap unit includes an edge portion that protrudes downward and is provided on the circumference of the toner outlet. The edge portion of the cap unit has tips on both sides in the longitudinal direction. Each of the tips has a pointed shape that is pointed in the longitudinal direction so as to be separated from the center of the toner outlet.

That is, the shutter unit 34d includes the shutter seal 36 (seal member) on the surface to face the toner outlet W. The cap unit 34Y includes the edge portion 34r that protrudes downward and is formed on the circumference of the toner outlet W. The edge portion 34r has the vertex portions 34r1 on the leading and trailing sides in the longitudinal direction. Each of the vertex portions 34r1 has a pointed shape.

In the toner container, when viewed from below in the vertical direction, the edge portion of the cap unit is a hexagonal edge portion having parallel portions that are opposed to each other along the longitudinal direction, and two vertex portions positioned on the tips opposing to each other in the longitudinal direction.

In the toner container, the toner outlet is formed to be hexagonally shaped so as to follow the hexagonal shape of the edge portion when viewed from below in the vertical direction.

In the toner container, the tips of the edge portion have tapered shapes so that the amount of downward protrusion gradually decreases according to the distance from the center of the toner outlet.

In the toner container, the edge portion is formed so that the planes perpendicular to the longitudinal direction have tapered shapes and the amount of downward protrusion gradually decreases according to the distance from the center of the toner outlet.

In the toner container, the seal member is disposed so as to protrude in the longitudinal direction from one end of the shutter unit in the closing direction.

In the toner container, the cap unit includes a cylindrical cavity formed inside thereof so as to extend in the longitudinal direction and a toner fall path that has a columnar shape with a constant flow passage area from a lower circumferential surface of the cylindrical cavity to the toner outlet.

In the toner container, the container body includes a spiral-shaped projection formed on inner circumferential surface thereof and is held to be rotatable with respect to the cap unit.

The toner container is arranged in a body of an image forming apparatus.

In this way, the seal member is provided on the surface of the shutter unit facing the toner outlet, and the tips of the edge portion have tapered shapes so that the edge portion provided on the circumference of the toner outlet does not cause the seal member to be peeled or damaged. Accordingly, a toner container and an image forming apparatus can be provided such that toner contained in the toner container is less likely to scatter to the outside of the toner container in attachment/detachment operation of the toner container to/from the body of the image forming apparatus.

As described above, in the toner container 32Y according to the first embodiment, because the vertical surfaces 34s, on which the shutter rails 34t guiding the open/close operation of the shutter unit 34d are formed, extend from the end of the shutter unit 34d, which is at a position of closing the toner outlet W in the closing direction, to the protruding position in the longitudinal direction, a timing at which the shutter closing mechanisms 73d arranged in the body of the image forming apparatus 100 release holding of the shutter unit 34d using the vertical surfaces 34s as references can be delayed as compared to a timing at which the shutter closing mechanisms 73d completely close the shutter unit 34d. Therefore, a space for arranging the toner container 32Y can be effectively secured in the body of the image forming apparatus 100 and the toner container 32Y can be set to the body of the image forming apparatus 100 with high fitting capability and operability, so that it is possible to obviate troubles caused by the scatter of toner contained in the toner container 32Y from to the outside of the toner container 32Y in the detachment operation of the toner container 32Y from the body of the image forming apparatus 100 even when the toner container 32Y is configured to discharge toner from the toner outlet W by the toner's own weight.

In a conventional toner container, when a flow passage area of a toner conveying path or an opening area of a toner outlet is increased, it is possible to configure a shutter unit so that the shutter unit can slide to open and close the toner outlet in association with attachment/detachment operation of the toner container to/from the body of an image forming apparatus, in order that attachment/detachment operation of the toner container to/from the apparatus body is accomplished by a single action when a longitudinal direction of the toner container is set as an attachment/detachment direction. In this case, however, it is necessary to configure the shutter unit closing the toner outlet so as not to easily move so that the toner contained in the toner container that is isolated from, and not arranged in, the body of the image forming apparatus does not leak toner to the outside of the toner container.

The toner container described above is a toner container that is detachably attached to the body of an image forming apparatus with a longitudinal direction of the toner container kept horizontal, and includes: a cylindrical container body that has an opening on one end thereof in the longitudinal direction, and is configured to convey toner contained therein toward the opening; a cap unit into which the opening of the container body is inserted, and which includes a toner outlet at a bottom portion thereof for discharging toner, which has been discharged from the opening of the container body, to the outside of the toner container in a vertically downward direction; and a shutter unit that is held on the bottom portion of the cap unit, and moves along an outer periphery of the cap unit to thereby open and close the toner outlet. The shutter unit includes: a shutter main unit that is engaged with a rail unit arranged on the cap unit, and moves along the rail unit to thereby open and close the toner outlet; and a deformable shutter member that is integrally formed on the shutter main unit, and is elastically deformable in a vertical direction by using a connection position between the deformable shutter member and the shutter main unit as a base point. The deformable shutter member includes a stopper that comes into contact with a contact portion formed on the cap unit to thereby regulate a motion of the shutter unit in a direction to open the toner outlet that has been closed; and a stopper releasing unit that protrudes downward in the vertical direction, and displaces the stopper upward along with upward elastic deformation of the deformable shutter member upon receiving an external force from below to thereby release a contact state between the stopper and the contact portion.

More specifically, the shutter unit 34d includes the deformable shutter member 34d2 that is formed to be elastically deformable by using a connection position, as a base point, between the deformable shutter member 34d2 and the shutter main unit 34d1 that moves along the rail unit of the cap unit 34Y to open and close the toner outlet. The deformable shutter member 34d2 includes the stoppers 34d22 that regulate a motion of the shutter unit 34d in a direction to open the toner outlet that has been closed, and the stopper releasing unit 34d21 that releases a contact state between the stoppers 34d22 and the contact portions 34n5 upon receiving an external force from below.

In the toner container described above, the shutter deformation unit is disposed on the side of the container body in the longitudinal direction with respect to the shutter main unit, the stopper is formed on the tip, which is away from the shutter main unit, of the deformable shutter member, and the stopper releasing unit is formed between the stopper and the connection position.

In the toner container described above, the cap unit includes a housing unit that maintains a deformed state of the deformable shutter member when the shutter unit opens the toner outlet and houses the deformable shutter member.

In the toner container described above, the shutter main unit further includes a second stopper that comes into contact with a second contact portion formed on the cap unit and regulates a motion of the shutter unit in a direction opposite to a direction in which the stopper performs regulation.

In the toner container described above, the cap unit includes a cylindrical cavity formed inside thereof to extend in the longitudinal direction and a toner fall path that has a columnar shape with a constant flow passage area from a lower circumferential surface of the cylindrical cavity to the toner outlet.

In the toner container described above, the container body includes a spiral-shaped projection formed on inner circumferential surface thereof and is held to be rotatable with respect to the cap unit.

The toner container is arranged in the body of the image forming apparatus.

In this way, according to the configuration, the shutter unit includes the deformable shutter member that elastically deforms by using the connection position between the shutter main unit and the deformable shutter member as a base point, and the deformable shutter member includes the stopper that regulates a motion of the shutter unit in the opening direction and the stopper releasing unit that releases the stopper. Accordingly, a toner container and an image forming apparatus can be provided in which the shutter unit that opens and closes the toner outlet is not easily moved when the toner container is isolated from the image forming apparatus.

As described above, the toner container 32Y of the first embodiment includes, on the shutter unit 34d, the deformable shutter member 34d2 that is elastically deformed by using the connection position of the shutter main unit 34d1 as a base point, and also includes, on the deformable shutter member 34d2, the stoppers 34d22 for regulating the motion of the shutter unit 34d in the opening direction and the stopper releasing unit 34d21 for releasing the regulation. Therefore, a space for arranging the toner container 32Y can be effectively secured in the body of the image forming apparatus 100 and the toner container 32Y can be set to the image forming body of the image forming apparatus 100 with high fitting capability and operability, so that it is possible to prevent the shutter unit 34d that opens and closes the toner outlet W from being easily moved when the toner container 32Y is isolated even when the toner container 32Y is configured to discharge toner from the toner outlet W by the toner's own weight.

### Second Embodiment

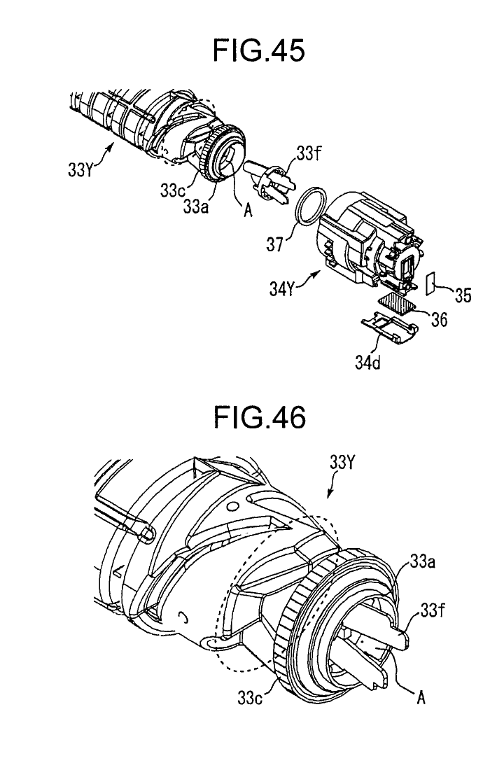

A second embodiment will be described in detail below with reference to FIGS. 45 to 52. A toner container according to the second embodiment is different from the first embodiment in that the stirring member 33f is differently configured.

Referring to FIG. 45, the toner container 32Y of the second embodiment mainly includes, similarly to the first embodiment, the container body 33Y (bottle body) and the cap unit 34Y (bottle cap) arranged at the head portion of the container body. The toner container 32Y of the second embodiment further includes, in addition to the container body 33Y and the cap unit 34Y, the stirring member 33f, the cap seal 37, the shutter unit 34d, the shutter seal 36 as a seal member, and the RFID chip 35 as an electronic-information storage member.

Referring to FIGS. 45 and 46, in the toner container 32Y of the second embodiment, similarly to the first embodiment, the stirring member 33f that rotates with the container body 33Y is fitted to the bottle opening 33a (the opening A).

The stirring member 33f is formed of a pair of plate members that extend from the cavity B in the cap unit 34Y to the inside of the container body 33Y (also see FIG. 50). The stirring member 33f differs from that of the first embodiment in that the plate members in the pair are alternately tilted in the second embodiment. The stirring member 33f is configured such that the tip thereof reaches the upper side of the toner outlet W in the cap unit 34Y and the other end thereof (the end on the opposite side) reaches the scooping portion (a portion surrounded by a dashed circle in FIGS. 45 and 46) when the cap unit 34Y and the container body 33Y are assembled together. Rotation of the stirring member 33f in conjunction with the rotation of the opening A of the container body 33Y improves the toner discharging performance from the opening A. In particular, the stirring member 33f according to the second embodiment improves toner stirring capability at front and back positions of the opening A because the pair of plate members are alternately tilted.

Referring to FIGS. 45 and 46, engaging members (convex portions), which are engaged with claw members 34j (see FIG. 50) of the cap unit 34Y in order to connect the container body 33Y with the cap unit 34Y, are formed around an outer circumference of the bottle opening 33a of the container body 33Y. As described above, the container body 33Y (that has the integrally formed gear 33c) is engaged with the cap unit 34Y so as to be relatively rotatable against the cap unit 34Y.

The inner diameter of a head portion of the container body 33Y (near the position where the gear 33c is formed) is smaller than the inner diameter of a container portion containing toner (the position where the spiral-shaped projection 33b is formed) (see FIG. 50).

The scooping portion (the portion surrounded by the dashed circle in FIGS. 45 and 46), of which inner circumferential surface protrudes inward, is provided on the head portion of the container body 33Y. Toner conveyed toward the opening A by the spiral-shaped projection 33b in association with the rotation of the container body 33Y is scooped, by the scooping portion (the portion surrounded by the dashed circle in FIGS. 45 and 46), into a small-diameter portion of the head portion. The toner scooped into the small-diameter portion of the head portion is stirred by the stirring member 33f, and is discharged to the cavity B of the cap unit 34Y through the opening A.

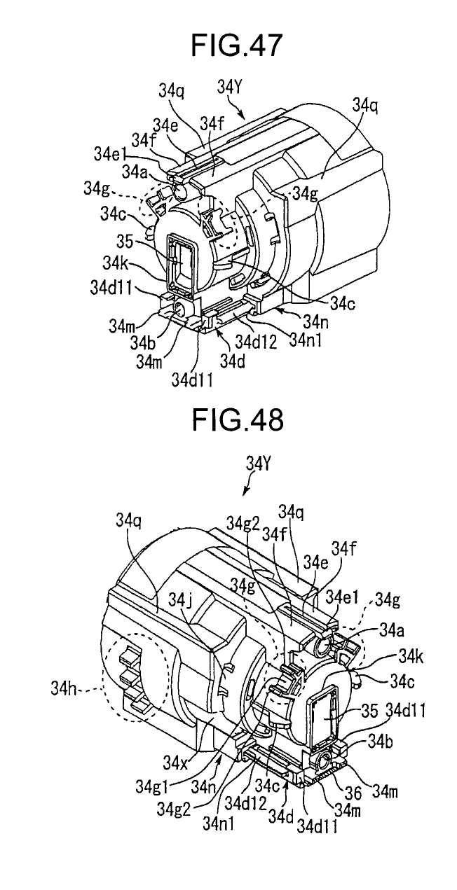

Referring to FIGS. 47 to 50, the shutter unit 34d, the shutter seal 36, the cap seal 37 (seal member), and the RFID chip 35 (electronic-information storage member) are arranged on the cap unit 34Y of the toner container 32Y.

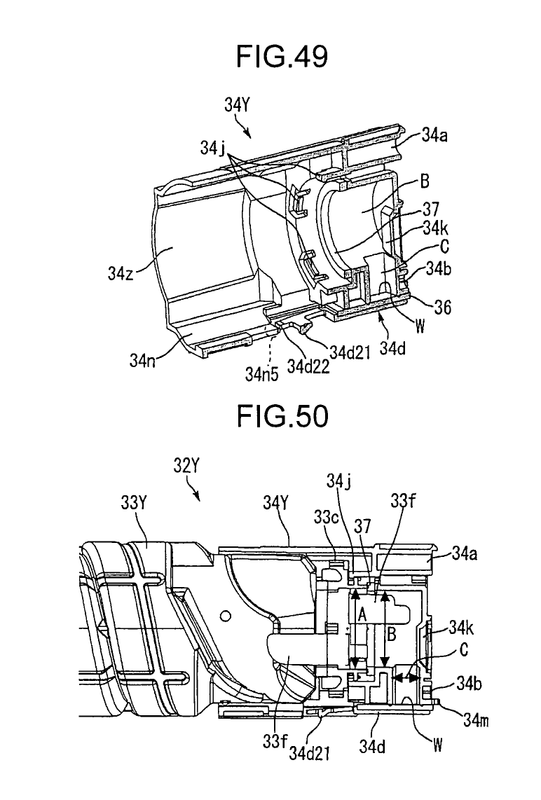

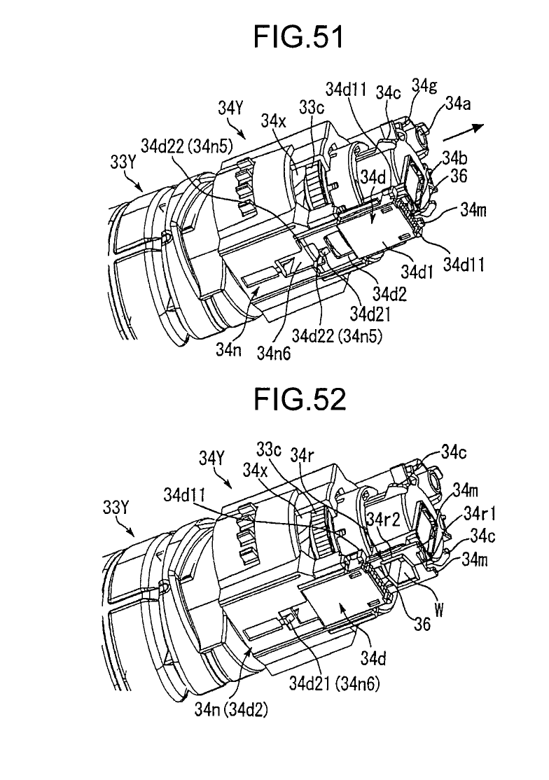

The cap unit 34Y includes the insertion portion 34z with an inner diameter greater than the inner diameter of the cavity B (see FIG. 49), and the opening A of the container body 33Y is inserted into the insertion portion 34z. Referring to FIGS. 49 and 52, the toner outlet W is formed at the bottom portion of the cap unit 34Y to allow toner that has been discharged from the opening A of the container body 33Y to be discharged to the outside of the toner container in a vertically downward direction (fall by own weight). The shutter unit 34d for opening and closing the toner outlet W is held in a slidable manner at the bottom portion of the cap unit 34Y. More specifically, the shutter unit 34d relatively moves in the longitudinal direction from the cap unit 34Y side to the container body 33Y side (movement to the left in FIG. 50) to open the toner outlet W. Furthermore, the shutter unit 34d relatively moves in the longitudinal direction from the container body 33Y side to the cap unit 34Y side (movement to the right in FIG. 50) to close the toner outlet W. The open/close operation of the shutter unit 34d (the open/close operation of the toner outlet W) is performed in association with the attachment/detachment operation of the toner container 32Y to the toner-container holder 70 (the body of the image forming apparatus 100) in the longitudinal direction. FIGS. 51 and 52 illustrate operation of the shutter unit 34d from start to completion of opening the toner outlet W.

Referring to FIGS. 47 and 48, the first hole 34a (main guide hole) is formed on the upper portion (ceiling portion) of the cap unit 34Y such that the first hole 34a extends in the longitudinal direction from the end face of the cap unit 34Y that is perpendicular to the longitudinal direction. The first hole 34a functions as a main guide for positioning the cap unit 34Y in the body of the image forming apparatus 100. More specifically, the first hole 34a of the cap unit 34Y is engaged with the main guide pin 73a of the cap holder 73 in association with the attachment operation of the toner container 32Y to the toner-container holder 70 in the longitudinal direction.

The second hole 34b (sub-guide hole) is formed at the lower portion (bottom portion) of the cap unit 34Y such that the second hole 34b extends in the longitudinal direction from the end face of the cap unit 34Y that is perpendicular to the longitudinal direction so as not to reach the position of the toner outlet W. The second hole 34b functions as a sub-guide for positioning the cap unit 34Y in the body of the image forming apparatus 100. More specifically, the second hole 34b of the cap unit 34Y is engaged with the sub-guide pin 73b of the cap holder 73 in association with the attachment operation of the toner container 32Y to the toner-container holder 70 in the longitudinal direction. With the use of the two holes 34a and 34b thus configured, the position of the cap unit 34Y is fixed in the toner-container holder 70.

Referring to FIGS. 47 and 48, shoulder portions 34q are formed on the outer circumference of a portion where the insertion portion 34z is formed and on both sides on the upper portion of the cap unit 34Y. Each of the shoulder portions 34q has a flat top face and a flat lateral face that are approximately perpendicular to each other.

When the toner container 32Y is attached to the toner-container holder 70, the shoulder portions 34q come into contact with positioning members (not illustrated), which are arranged on the cap holder 73 of the toner-container holder 70, in association with the attachment operation. Accordingly, backlash of the cap unit 34Y in the cap holder 73 can be suppressed, so that the cap unit 34Y can be smoothly attached to the cap holder 73.

Referring to FIGS. 47 and 48, the lateral projections 34c (pressed portions) are arranged on both lateral sides of the cap unit 34Y and protrude from the outer circumferential surface of the cap unit 34Y. The lateral projections 34c according to the second embodiment are pressed in a direction against a force in the attachment direction (or the detachment direction) by pressing portions (not illustrated) of the cap holder 73 when the cap unit 34Y is attached to (or detached from) the cap holder 73 of the toner-container holder 70 (the body of the image forming apparatus 100). Therefore, during the attachment operation (or the detachment operation) of the toner container 32Y to the cap holder 73, after a user feels a force against an operating force in the attachment direction (or the detachment direction) at the position where the lateral projections 34c are engaged with the pressing portions, the user increases the operating force in the attachment direction (or the detachment direction) to complete the attachment operation (or the detachment operation) instantly. Thus, the user gains a good click feeling in the attachment operation (or the detachment operation) of the toner container 32Y to the cap holder 73.

More specifically, as illustrated in FIGS. 47 and 48, the lateral projections 34c according to the second embodiment are formed in ridge shapes along the longitudinal direction (attachment direction). The ridge shapes of the lateral projections 34c are formed such that the slopes on the tip side become more gentle than the slopes on the container body side. Therefore, the user can smoothly perform the attachment/detachment operation with a good click feeling when performing the attachment/detachment operation of the toner container 32Y to the cap holder 73.

Referring to FIGS. 47 and 48, the convex portions 34g and 34h for ensuring the incompatibility of the toner container 32Y with toner containers of other colors are formed on the outer circumferential surface of the cap unit 34Y. The convex portions 34g and 34h are configured to engage with the lateral grooves 73c of the cap holder 73 when the attachment operation of the toner container 32Y to the toner-container holder 70 is correctly performed (when the toner container 32Y is attached to a correct position in the toner-container holder 70). With the above configuration, it is possible to prevent a toner container for a certain color (for example, a toner container for yellow) from being set in a toner-container holder for a different color (for example, a toner-container holder for cyan), thereby preventing a failure to form a desired color image. That is, it is possible to prevent the toner container from being erroneously set in the toner-container holder.

Referring to FIG. 48, the convex portions 34g (incompatibly shaped portions) are two projections that are radially formed on the upper portion of the tip of the cap unit 34Y. Each of the two projections (the incompatibly shaped portions 34g) includes a base portion 34g1 and two incompatible claw members 34g2 projecting from the base portion 34g1. The base portion 34g1 has a trapezoidal shape that spreads out outward. The two incompatible claw members 34g2 are arranged so as to radially project outward from the top face of the base portion 34g1.

The incompatible claw members 34g2 are cut off depending on the type (color) of toner contained in the toner container so as to fulfill the incompatible function for each color. That is, some of the incompatible claw members 34g2 are cut off with a cutting tool, such as a nipper or a cutter, from the cap unit 34Y having the four incompatible claw members 34g2 in total on the left and right sides, so that the incompatibly shaped portions 34g of various shapes can be formed. With the above configuration, it becomes unnecessary to manufacture the same number of molds as the number of types of the toner containers (cap units), and it becomes possible to form a plurality of types of incompatible cap units by using one mold to enable to reduce an entire manufacturing cost for producing the plurality of types of the toner containers.

Referring to FIG. 48, a relatively large space is set between the two incompatible claw members 34g2 in the incompatibly shaped portions 34g so that the incompatible claw members 34g2 can be easily cut off by using a cutting tool such as a nipper or a cutter.

Referring to FIG. 48 and other related drawings such as FIGS. 49 to 52, the cap unit 34Y of the second embodiment includes an incompatible convex portion 34h for identifying a destination of the toner container (for example, for domestic use or for export to North America, Europe, and other countries and regions). The convex portion 34h is configured to be engaged with an engagement member (not illustrated) formed in the bottle holder 72 when the body of the image forming apparatus 100 as a setting object is compatible (when the cap unit is set in the correct body of the image forming apparatus 100).

In the toner container 32Y according to the second embodiment, similarly to the first embodiment, the shutter seal 36 (seal member) is provided on the surface of the shutter unit 34d that faces the toner outlet W, and the vertex portions 34r1 of the edge portion 34r are formed in pointed shapes so that the edge portion 34r provided on the circumference of the toner outlet W of the cap unit 34Y does not cause the shutter seal 36 to be peeled or damaged.

Therefore, also in the second embodiment, similarly to the first embodiment, a space for arranging the toner container 32Y can be effectively secured in the body of the image forming apparatus 100 and the toner container 32Y can be set to the body of the image forming apparatus 100 with high fitting capability and operability, so that it is possible to prevent toner contained in the toner container 32Y from scattering to the outside of the toner container 32Y in association with the attachment/detachment operation of the toner container 32Y to/from the body of the image forming apparatus 100 even when the toner container 32Y is configured to discharge toner from the toner outlet W by the toner's own weight.

Also in the toner container 32Y according to the second embodiment, similarly to the first embodiment, because the vertical surfaces 34s, on which the shutter rails 34t guiding the open/close operation of the shutter unit 34d are formed, extend from the end of the shutter unit 34d, which is at a position of closing the toner outlet W in the closing direction, to the protruding position in the longitudinal direction, a timing at which the shutter closing mechanisms 73d arranged in the body of the image forming apparatus 100 release holding of the shutter unit 34d using the vertical surfaces 34s as references can be delayed in comparison to a timing at which the shutter closing mechanisms 73d completely close the shutter unit 34d.

Therefore, also in the second embodiment, similarly to the first embodiment, a space for arranging the toner container 32Y can be effectively secured in the body of the image forming apparatus 100 and the toner container 32Y can be set to the body of the image forming apparatus 100 with high fitting capability and operability, so that it is possible to prevent toner contained in the toner container 32Y from scattering to the outside of the toner container 32Y in association with detachment operation of the toner container 32Y from the body of the image forming apparatus 100 even when the toner container 32Y is configured to discharge toner from the toner outlet W by the toner's own weight.

Also in the toner container 32Y of the second embodiment, similarly to the first embodiment, the shutter unit 34d includes the deformable shutter member 34d2 that is elastically deformed by using the connection position of the shutter main unit 34d1 as a base point, and also includes, on the deformable shutter member 34d2, the stoppers 34d22 for regulating the motion of the shutter unit 34d in the opening direction and the stopper releasing unit 34d21 for releasing the regulation.

Therefore, also in the second embodiment, similarly to the first embodiment, a space for arranging the toner container 32Y can be effectively secured in the body of the image forming apparatus 100 and the toner container 32Y can be set to the body of the image forming apparatus 100 with high fitting capability and operability, so that it is possible to prevent the shutter unit 34d that opens and closes the toner outlet W from being easily moved when the toner container 32Y remains isolated even when the toner container 32Y is configured to discharge toner from the toner outlet W by the toner's own weight.

### Third Embodiment

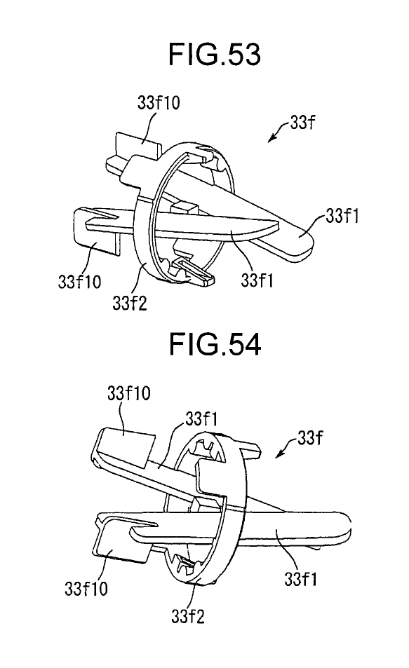

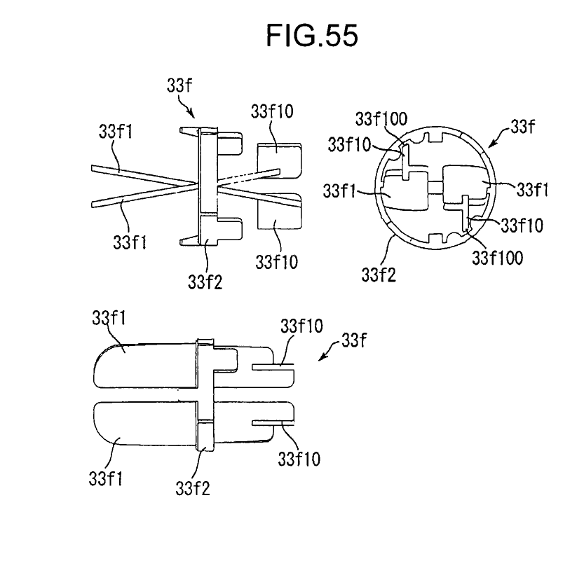

A third embodiment will be described in detail below with reference to FIGS. 53 to 56. A toner container according to the third embodiment is different from the second embodiment in that the stirring member 33f is differently configured.

The toner container 32Y of the third embodiment mainly includes, similarly to the second embodiment, the container body 33Y (bottle body) and the cap unit 34Y (bottle cap) arranged on the head portion of the container body. The toner container 32Y of the third embodiment further includes, in addition to the container body 33Y and the cap unit 34Y, the stirring member 33f, the cap seal 37, the shutter unit 34d, the shutter seal 36 as a seal member, and the RFID chip 35 as an electronic-information storage member (see FIG. 45).

In the toner container 32Y of the third embodiment, similarly to the second embodiment, the stirring member 33f that rotates in association with the container body 33Y is fitted to the bottle opening 33a (the opening A). Specifically, referring to FIGS. 53 to 55, a fitting portion 33f2 of the stirring member 33f is press-fitted to the bottle opening 33a (the opening A) illustrated in FIG. 45.

As illustrated in FIGS. 53 to 55, the stirring member 33f of the third embodiment includes plate members 33f1 being a pair, which extends from the cavity B in the cap unit 34Y toward the inside of the container body 33Y. The plate members 33f1 of the stirring member 33f are alternately tilted, similarly to the second embodiment. The stirring member 33f is configured such that the tip thereof (on the side where push plates 33f10 are formed) reaches the upper side of the toner outlet W in the cap unit 34Y and the other end thereof (the end on the opposite side) reaches the scooping portion (the portion surrounded by the dashed circle in FIGS. 45 and 46) when the cap unit 34Y and the container body 33Y are assembled together. Rotation of the stirring member 33f in conjunction with the rotation of the opening A of the container body 33Y improves the toner discharging performance of the opening A.

As illustrated in FIGS. 53 to 55, the stirring member 33f of the third embodiment is different from the second embodiment in that the push plates 33f10 are arranged on the tips of the plate members 33f1 (on the side toward the inside of the cap unit 34Y). The push plates 33f10 are plate members that stand approximately perpendicular to the main bodies of the plate members 33f1. Each of the push plates 33f10 includes a tapered portion 33f100 on the outer circumference thereof.

As described above, because the push plates 33f10 are arranged on the tips of the plate members 33f1 of the stirring member 33f, the push plates 33f10 push toner toward the toner outlet W in the cap unit 34Y in association with the rotation of the stirring member 33f. Therefore, even when the cap unit 34Y is clogged with toner in the vicinity of the toner outlet W (the toner fall path C), the toner can be smoothly discharged from the toner outlet W.

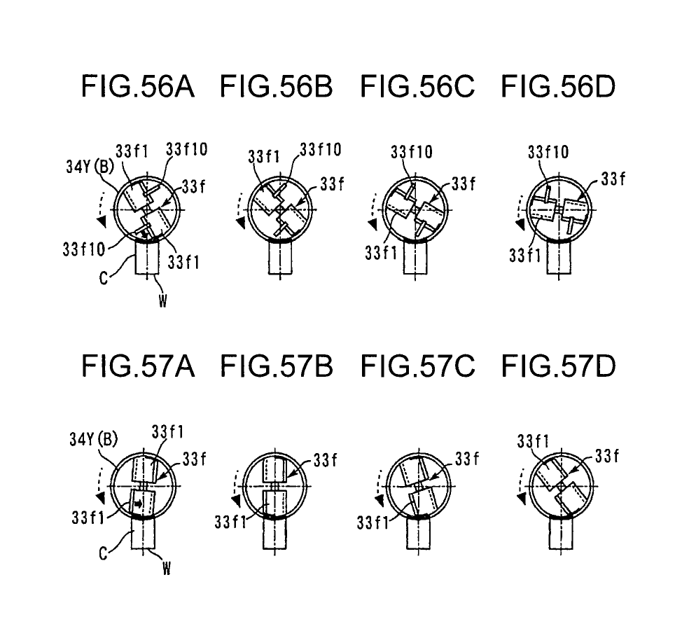

FIGS. 56A to 56D are schematic front views of how the stirring member 33f rotates in the toner container 32Y that has the stirring member 33f with the push plates 33f10 (the stirring member 33f of the third embodiment). On the other hand, FIGS. 57A to 57D are schematic front views of how the stirring member 33f rotates in the toner container 32Y that has the stirring member 33f without the push plates 33f10 (the stirring member 33f of the second embodiment).

In FIGS. 56A and 57A, black arrows indicate a toner conveying direction in which the stirring member 33f conveys toner toward the toner outlet W (the toner supply port 73w).

As illustrated in FIG. 57A, when the push plates 33f10 are not arranged on the tips of the plate members 33f1 of the stirring member 33f, the push plates 33f10 convey toner in a circumferential direction along the inner circumference of the cap unit 34Y in association with the rotation of the stirring member 33f. By contrast, as illustrated in FIG. 56A, when the push plates 33f10 are arranged on the tips of the plate members 33f1 of the stirring member 33f, the push plates 33f10 convey toner toward the toner outlet W (conveyance in an approximately normal direction with respect to the inner circumference of the cap unit 34Y) in association with the rotation of the stirring member 33f.

In the toner container 32Y according to the third embodiment, similarly to each of the above-described embodiments, the shutter seal 36 (seal member) is provided on the surface of the shutter unit 34d to face the toner outlet W, and the vertex portions 34r1 of the edge portion 34r are formed in pointed shapes so that the edge portion 34r provided on the circumference of the toner outlet W of the cap unit 34Y does not cause the shutter seal 36 to be peeled or broken.

Therefore, also in the third embodiment, similarly to each of the above-described embodiments, a space for arranging the toner container 32Y can be effectively secured in the body of the image forming apparatus 100 and the toner container 32Y can be set to the body of the image forming apparatus 100 with high fitting capability and operability, so that it is possible to prevent toner contained in the toner container 32Y from scattering to the outside of the toner container 32Y in association with attachment/detachment operation of the toner container 32Y to the body of the image forming apparatus 100 even when the toner container 32Y is configured to discharge toner from the toner outlet W by the toner's own weight.

### Fourth Embodiment

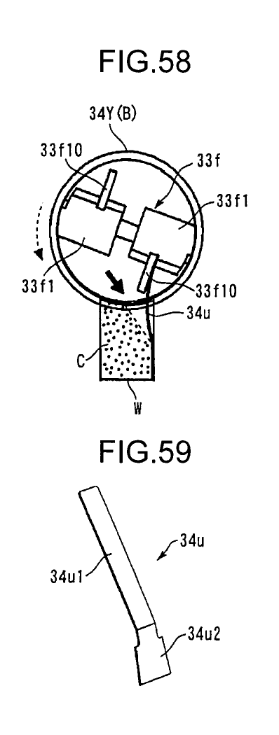

A fourth embodiment will be described in detail below with reference to FIGS. 58, 59, and 60A to 60G. A toner container according to the fourth embodiment is different from the third embodiment in that a flexible member 34u is disposed near the toner outlet W of the cap unit 34Y.

The toner container 32Y of the fourth embodiment mainly includes, similarly to the third embodiment, the container body 33Y (bottle body) and the cap unit 34Y (bottle cap) arranged on the head portion of the container body. The toner container 32Y of the fourth embodiment further includes, in addition to the container body 33Y and the cap unit 34Y, the stirring member 33f, the cap seal 37, the shutter unit 34d, the shutter seal 36 as a seal member, and the RFID chip 35 as an electronic-information storage member (see FIG. 45).

In the toner container 32Y of the fourth embodiment, similarly to the third embodiment, the stirring member 33f that rotates in conjunction with the container body 33Y is fitted to the bottle opening 33a (the opening A).

As illustrated in FIG. 58, the stirring member 33f of the fourth embodiment includes the plate members 33f1 being a pair, which extends from the cavity B in the cap unit 34Y toward the inside of the container body 33Y (which are alternately tilted). The stirring member 33f of the fourth embodiment further includes the push plates 33f10 on the tips of the plate members 33f1 (on the side toward the inside of the cap unit 34Y), similarly to the third embodiment.

Referring to FIGS. 58, 59, and 60A to 60G, the cap unit 34Y of the fourth embodiment is different from the third embodiment in that the cap unit 34Y includes a flexible member 34u made of flexible material such as mylar with a thickness of about 0.188 mm to 0.5 mm extending from the toner fall path C to the cavity B. More specifically, as illustrated in FIG. 59, a part of the flexible member 34u is bent, and a fixation portion 34u2 (with a width wider than a flexible portion 34u1) as an attachment surface is attached (fixed) to the inner wall of the toner fall path C (the inner wall on the side near the toner outlet W and on the downstream side of the stirring member 33f in the rotational direction). Specifically, the fixation portion 34u2 is attached to the inner wall of the toner fall path C so that the bent portion of the flexible member 34u can be located in the toner fall path C. The flexible portion 34u1 of the flexible member 34u is a free end and extends from the toner fall path C to the inside of the cavity B. The tip of the flexible portion 34u1 comes into contact with the push plates 33f10 in association with the rotation of the stirring member 33f, so that even when the cap unit 34Y is clogged with toner in the vicinity of the toner outlet W (the toner fall path C) is clogged with toner, the toner can be smoothly discharged from the toner outlet W.

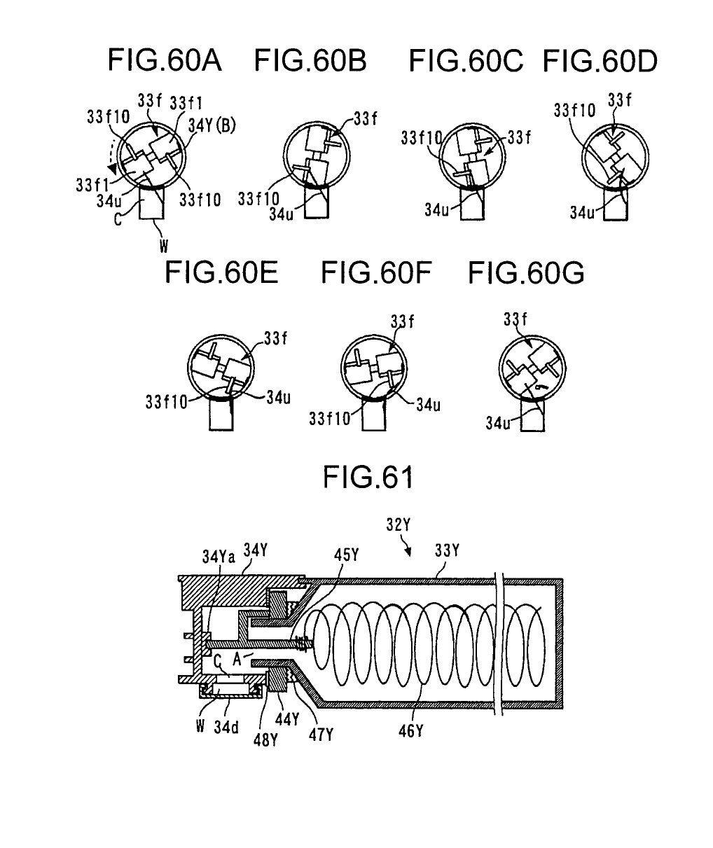

More specifically, as illustrated in FIGS. 60A to 60D, the push plates 33f10 push the flexible member 34u (the flexible portion 34u1) in association with the rotation of the stirring member 33f, so that the flexible member 34u is gradually bent in an arched shape. At this time, even when the portion between the inner wall of the toner fall path C and the flexible member 34u is clogged with toner with the stirring member 33f being in the state illustrated in FIG. 60A, because the flexible member 34u is greatly bent in an arched shape and the space between the inner wall of the toner fall path C and the flexible member 34u increases as illustrated in FIG. 60D, toner clogging the toner fall path C is loosened.

Thereafter, as illustrated in FIG. 60E, a planer portion of the push plate 33f10 and a planer portion of the flexible member 34u overlap each other, and the flexible member 34u is deformed to become nearly flat from the fixation portion 34u2 to the flexible portion 34u1. During this deformation, the space between the flexible member 34u and the toner becomes large to promote the toner for further loosening and the toner is further supplied to the space by being pushed by the push plate 33f10 (the state illustrated in FIG. 58). Accordingly, toner discharging efficiency and toner loosening performance at the toner outlet W (the toner fall path C) are promoted. Thereafter, as illustrated in FIG. 60F, the flexible member 34u gets completely warped, and the contact between the flexible member 34u and the push plate 33f10 is released. Then, as illustrated in FIG. 60G, the flexible member 34u is returned to the initial state by the elastic force of the flexible member 34u. At this time, the toner receives a restoring force caused by the elasticity of the flexible member 34u, so that the toner loosening and the toner discharging at the toner fall path C are promoted.

The shape of the flexible member 34u is not limited to that described in the fourth embodiment. For example, the flexible member 34u may not have a bent portion, or may have the fixation portion 34u2 in a different shape.

In the toner container 32Y according to the fourth embodiment, similarly to each of the above-described embodiments, the shutter seal 36 (seal member) is provided on the surface of the shutter unit 34d that faces the toner outlet W, and the vertex portions 34r1 of the edge portion 34r are formed in pointed shapes so that the edge portion 34r provided on the circumference of the toner outlet W of the cap unit 34Y does not cause the shutter seal 36 to be peeled or damaged.

Therefore, also in the fourth embodiment, similarly to each of the above-described embodiments, a space for arranging the toner container 32Y can be effectively secured in the body of the image forming apparatus 100 and the toner container 32Y can be set to the body of the image forming apparatus 100 with high fitting capability and operability, so that it is possible to prevent toner contained in the toner container 32Y from scattering to the outside of the toner container 32Y in association with attachment/detachment operation of the toner container 32Y to the body of the image forming apparatus 100 even when the toner container 32Y is configured to discharge toner from the toner outlet W by the toner's own weight.

In the above embodiments, only toner is contained in the toner containers 32Y, 32M, 32C, and 32K. However, it is possible to contain two-component developer in the toner containers 32Y, 32M, 32C, and 32K for an image forming apparatus that appropriately supplies two-component developer formed of toner and carrier to a developing device. Even for this case, the same advantages as described above can be achieved.

In the above embodiments, a part or all of the image forming units 6Y, 6M, 6C, and 6K may be configured as process cartridges. Even for this case, the same advantages as described above can be achieved.

In the above embodiments, the container body 33Y is made rotatable so that toner contained in the container body 33Y can be conveyed toward the opening A. However, the container body 33Y may be configured such that the container body 33Y is non-rotatably held by the toner-container holder 70 together with the cap unit 34Y, and the container body 33Y includes, inside thereof, a conveying member (for example, a conveying member that has a conveying coil or a plurality of conveying blades on a shaft portion and that rotates in a predetermined direction by a gear separated from the container body) for conveying toner toward the opening A so that toner contained in the container body 33Y can be conveyed toward the opening A (see FIG. 61).

More specifically, as illustrated in FIG. 61, the toner container 32Y mainly includes the container body 33Y, a gear 44Y, and the cap unit 34Y (bottle cap). The opening A is arranged on the head portion of the container body 33Y, and the gear 44Y is rotatably arranged on the outer circumference of the opening A. The gear 44Y engages with the driving gear of the body of the image forming apparatus 100 to rotate a coil 46Y about an axis of rotation. The opening A is used for discharging toner contained in the container body 33Y to the space inside the cap unit 34Y. A rotary shaft 45Y is integrally arranged on the gear 44Y, and the spiral-shaped coil 46Y (conveying coil) is connected to the rotary shaft 45Y. One end of the rotary shaft 45Y is supported by a bearing 34Ya of the cap unit 34Y. The coil 46Y is extended from the opening A to the bottom portion inside the container body 33Y. The gear 44Y rotates around the container body 33Y to thereby rotate the rotary shaft 45Y and the coil 46Y. Therefore, toner contained in the container body 33Y is conveyed to the opening A side by a toner conveying force of the coil 46Y. The gear 44Y is inserted into the outer circumference of the opening A so as to be sandwiched by the container body 33Y and the cap unit 34Y. A rubber member 47Y is disposed between the gear 44Y and the container body 33Y on the side of one of the faces of the gear 44Y. A seal member 48Y is disposed between the gear 44Y and the cap unit 34Y on the other side of the gear 44Y. With this configuration, the sealing capability of the entirety of the toner container 32Y is ensured. That is, it is possible to prevent toner from leaking through a gap between any pairs of the gear 44Y, the container body 33Y, and the cap unit 34Y.

The present invention can also be applied to the above toner container 32Y similarly to the above embodiments. Accordingly, it is possible to achieve the same advantages of the above embodiments.

In the above embodiments, in each of the toner supply devices 60Y, 60M, 60C, and 60K, the toner conveying path formed with the toner tank (61Y), the toner conveyor (62Y, 63Y), and the toner-falling conveying path (64Y) has a reversed N-character shape (similarly to the shape of the Russian letter 14) as illustrated in FIG. 1 (an N-character shape when viewed from the rear side of FIG. 1). The toner conveyor (62Y, 63Y) for each color is provided on the upper side of the process cartridge (the image forming unit 6Y) for the corresponding color, and on the upper side of the opening for attachment and detachment of the process cartridge to the body of the image forming apparatus 100. The toner container (32Y), the toner tank (61Y) and the upstream side of the toner conveyor (62Y) for each color are provided on the upper side of the nearby process cartridge (the left neighbor in FIG. 1), not of the process cartridge for the corresponding color. With above configuration, in a tandem type image forming apparatus in which a plurality of process cartridges (image forming units) are arranged in parallel, a process cartridge (image forming unit) does not cause interference with the toner supply device when the attachment or detachment operation of the process cartridge is performed. In addition, it is possible to provide an image forming apparatus in which the layout of the toner containers and the process cartridges for the respective colors in the vertical direction can be achieved in a compact manner without variance in the amount of a toner supply.

It is understood that the present invention is not limited to the above-described embodiments, and the embodiments can be readily modified within the range of the technical concepts of the present invention. The number, positions, shapes of elements are not limited to those in the embodiments. The number, positions, shapes of elements suitable for embodying the present invention can be employed.

### INDUSTRIAL APPLICABILITY

As described above, a toner container and an image forming apparatus according to the present invention is useful for an image forming apparatus such as a copying machine, a printer, and a multifunction peripheral that has functions of the copying machine and the printer, and is particularly suitable for an apparatus that has a mechanism in which powder such as toner is housed, attached and supplied to the apparatus, and a system including the apparatus.

1. (canceled)

2. A toner container to be detachably attached to an image forming apparatus with a longitudinal direction of the toner container parallel to a horizontal direction, the toner container comprising:
a toner path which discharges toner to outside of the toner container in a vertically downward direction;
a stirrer movably disposed above the toner path; and
a flexible protrusion having an end fixed at the toner path and which extends upwardly, the flexible protrusion contacting the stirrer as the stirrer moves.

3. The toner container according to claim 2, wherein the stirrer is rotatable and includes a rotational axis which is parallel to the longitudinal direction of the toner container.

4. The toner container according to claim 3, wherein the flexible protrusion includes a bent portion,
wherein the end of the flexible protrusion which is fixed at the toner path is fixed to an inner wall of the toner path.

5. The toner container according to claim 2, wherein the flexible protrusion which is fixed at the toner path is fixed to an inner wall of the toner path on a downstream side in a moving direction of the stirrer.

6. The toner container according to claim 2, wherein the flexible protrusion includes a plate shape.

7. The toner container according to claim 2, wherein the flexible protrusion comprises mylar.

8. An image forming apparatus comprising the toner container according to claim 2.

9. A toner container to be detachably attached to an image forming apparatus with a longitudinal direction of the toner container parallel to a horizontal direction, the toner container comprising:
a toner path which discharges toner to outside of the toner container in a vertically downward direction;
means for stirring stirrer movably disposed above the toner path; and
means for flexing having an end fixed at the toner path and which extends upwardly, the means for flexing contacting the means for stirring as the means for stirring moves.

10. The toner container according to claim 9, wherein the means for stirring is rotatable and includes a rotational axis which is parallel to the longitudinal direction of the toner container.

11. The toner container according to claim 10, wherein the means for flexing includes a bent portion,
wherein the end of the means for flexing which is fixed at the toner path is fixed to an inner wall of the toner path.

12. The toner container according to claim 9, wherein the means for flexing which is fixed at the toner path is fixed to an inner wall of the toner path on a downstream side in a moving direction of the means for stirring.

13. The toner container according to claim 9, wherein the means for stirring includes a plate shape.

14. The toner container according to claim 9, wherein the means for flexing comprises mylar.

15. An image forming apparatus comprising the toner container according to claim 9.
